(19) United States
(12) Patent Application Publication
(10) Pub. No.: US 2025/0267646 A1
(43) Pub. Date: Aug. 21, 2025

(54) COMMUNICATION METHOD AND APPARATUS

(71) Applicant: HUAWEI TECHNOLOGIES CO., LTD., Shenzhen (CN)

(72) Inventor: Zhongfeng LI, Shanghai (CN)

(21) Appl. No.: 19/196,971

(22) Filed: May 2, 2025

Related U.S. Application Data
(63) Continuation of application No. PCT/CN2022/130078, filed on Nov. 4, 2022.

(51) Int. Cl. H04W 72/12; H04L 5/00

(52) U.S. Cl. CPC H04W 72/12; H04L 5/0055

(57) ABSTRACT

This application provides a communication method and apparatus. A first node may send N groups of data to a second node, where a first group of data in the N groups of data includes first control information and K pieces of first data, and a second group of data in the N groups of data includes second control information and P pieces of first data. This can improve data transmission reliability, and further satisfy a requirement for high reliability. Alternatively, if the second node does not obtain the first group of data due to a half-duplex problem, but the second node may further obtain a group of data other than the first group of data, a problem that data cannot be simultaneously sent and received due to half-duplex can be well resolved, so that the requirement for high reliability is satisfied.

### CROSS-REFERENCE TO RELATED APPLICATIONS

This application is a continuation of International Application No. PCT/CN2022/130078, filed on Nov. 4, 2022, the disclosure of which is hereby incorporated by reference in its entirety.

### TECHNICAL FIELD

This application relates to the field of communication technologies, and in particular, to a communication method and apparatus.

### BACKGROUND

With large-scale popularization of internet applications and network devices, people's requirements for wireless communication further increase. In addition to increasing a spectrum to improve a communication capacity, density of communication nodes in a network can also be increased, to improve requirements facing further challenges in terms of communication coverage, a communication delay, a communication capacity, communication energy consumption, and the like. Therefore, on a terminal device side, device-to-device (D2D) communication and V2X sidelink (SL) communication are introduced to support direct communication between terminal devices. In the future, the direct communication between the terminal devices has a wide range of applications, for example, communication between uncrewed aerial vehicles, direct communication between machines in factories, and device communication in augmented reality, virtual reality, and extended reality.

A typical communication manner of an SL is a half-duplex communication manner. This means that when sending data, a terminal device cannot receive data sent by another terminal device, or when receiving data, a terminal device cannot send data to another terminal device. In other words, the half-duplex communication manner cannot satisfy a requirement for high reliability.

### SUMMARY

This application provides a communication method and apparatus, to satisfy a requirement for high reliability.

According to a first aspect, a communication method is provided, including: A first node generates N groups of data, where N is an integer greater than 1; and the first node sends the N groups of data to a second node. A first group of data in the N groups of data includes first control information and K pieces of first data, the first control information indicates transmission of the K pieces of first data, and K is an integer greater than 1; and a second group of data in the N groups of data includes second control information and P pieces of first data, the second control information indicates transmission of the P pieces of first data, and P is an integer greater than or equal to 1.

It can be learned that the first node may send the N groups of data to the second node, where the first group of data in the N groups of data includes the first control information and the K pieces of first data, and the second group of data in the N groups of data includes the second control information and the P pieces of first data. In other words, if a packet loss occurs in the first group of data, the second node may still obtain the P pieces of first data based on the second control information. This can improve data transmission reliability, and further satisfy a requirement for high reliability. Alternatively, if the second node does not obtain the first group of data due to a half-duplex problem, but the second node may further obtain a group of data other than the first group of data, a problem that data cannot be simultaneously sent and received due to half-duplex can be well resolved, so that the requirement for high reliability is satisfied. In addition, one group of data includes one piece of control information and a plurality of pieces of first data, so that the piece of control information indicates transmission of the plurality of pieces of first data, and overheads are reduced.

It should be noted that, in this application, content included in a group of data other than the first group of data and the second group of data in the N groups of data is similar to content included in the first group of data or the second group of data. In other words, each of the N groups of data includes one piece of control information and at least one piece of first data. This facilitates self-decoding of each group of data. In a possible implementation, in this application, first data included in different groups of the N groups of data is same data.

In this application, quantities of pieces of first data included in the different groups of the N groups of data may be completely the same, partially the same, or completely different. This is not limited herein. It should be understood that, when the quantities of pieces of first data included in the different groups of the N groups of data are completely the same, there is no need to configure different quantities, and a configuration is simple. When the quantities of pieces of first data included in the different groups of the N groups of data are partially the same, configurations of different quantities can be reduced. When the quantities of pieces of first data included in the different groups of the N groups of data are completely different, a dynamic change of a channel and randomness of a half-duplex collision problem can be better handled. In this way, the requirement for high reliability is satisfied.

In a possible implementation, when the quantities of pieces of first data included in the different groups of the N groups of data are completely the same, a quantity of pieces of first data included in any one of the N groups of data is greater than 1. In this way, the problem that the data cannot be simultaneously sent and received due to the half-duplex can be well resolved, so that a specific guarantee can be provided for a receiver to obtain the first data, and the requirement for high reliability can be satisfied.

With reference to the first aspect, in a possible implementation, the method further includes: The first node receives first indication information sent by a third node, where the first indication information indicates a first resource used by the second node to send feedback information, and the feedback information includes an acknowledgement (ACK) or a non-acknowledgement (NACK) for the first data; and the first node sends the first indication information to the second node. It can be learned that the first resource used by the second node to send the feedback information is indicated by the third node to the first node, and then forwarded by the first node to the second node. When the first node is a centralized scheduling node, interference control is performed by using a centralized resource configuration.

The first indication information may be carried in, for example, medium access control (MAC) signaling or radio resource control (RRC) signaling.

According to a second aspect, a communication method includes: A second node receives N groups of data sent by a first node, where N is an integer greater than 1; a first group of data in the N groups of data includes first control information and K pieces of first data, the first control information indicates transmission of the K pieces of first data, and K is an integer greater than 1; and a second group of data in the N groups of data includes second control information and P pieces of first data, the second control information indicates transmission of the P pieces of first data, and P is an integer greater than or equal to 1. The second node obtains the first data based on the N groups of data.

It can be learned that the second node may receive the N groups of data sent by the first node, where the first group of data in the N groups of data includes the first control information and the K pieces of first data, and the second group of data in the N groups of data includes the second control information and the P pieces of first data. In other words, if a packet loss occurs in the first group of data, the second node may still obtain the P pieces of first data based on the second control information. This can improve data transmission reliability, and further satisfy a requirement for high reliability. Alternatively, if the second node does not obtain the first group of data due to a half-duplex problem, but the second node may further obtain a group of data other than the first group of data, a problem that data cannot be simultaneously sent and received due to half-duplex can be well resolved, so that the requirement for high reliability is satisfied. In addition, one group of data includes one piece of control information and a plurality of pieces of first data, so that the piece of control information indicates transmission of the plurality of pieces of first data, and overheads are reduced.

With reference to the second aspect, in a possible implementation, the method further includes: In response to a decoding error occurring after the first data in the N groups of data is received, and a cumulative quantity of transmission times of the first data in the first group to a N^{th} group not reaching a preset quantity of transmission times, the second node skips sending a NACK for the first data to the first node; or in response to a cumulative quantity of transmission times of the first data in the first group to a N^{th} group reaching a preset quantity of transmission times but a decoding error still occurring, the second node sends a NACK to the first node. It can be learned that, when the decoding error occurs after the first data in the N groups of data is received, and the cumulative quantity of transmission times of the first data in the first group to the N^{th} group does not reach the preset quantity of transmission times, the second node skips sending the NACK for the first data to the first node, so that the second node does not need to perform receive/transmit conversion, and time overheads caused by the receive/transmit conversion are reduced. When the cumulative quantity of transmission times of the first data in the first group to the N^{th} group reaches the preset quantity of transmission times but the decoding error still occurs, the second node sends the NACK to the first node, so that the first node can learn of a case in which the second node incorrectly decodes the first data.

“In response to a decoding error occurring after the first data in the N groups of data is received, and a cumulative quantity of transmission times of the first data in the first group to a N^{th} group not reaching a preset quantity of transmission times” may be understood as “when the decoding error occurs after the first data in the N groups of data is received, and the cumulative quantity of transmission times of the first data in the first group to the N^{th} group does not reach the preset quantity of transmission times”. Similarly, “in response to a cumulative quantity of transmission times of the first data in the first group to a N^{th} group reaching a preset quantity of transmission times but a decoding error still occurring” may be understood as “when the cumulative quantity of transmission times of the first data in the first group to the N^{th} group reaches the preset quantity of transmission times but the decoding error still occurs”.

With reference to the second aspect, in a possible implementation, a N^{th} piece of control information includes the cumulative quantity of transmission times of the first data in the first group to the N^{th} group. This indicates that the N^{th} piece of control information may include the cumulative quantity of transmission times of the first data in the first group to the N^{th} group. The control information is used for accumulating an index of the quantity of transmission times, so that the second node can obtain the cumulative quantity of transmission times, and further determine whether a maximum quantity of transmission times is reached, for example, further determine whether to perform hybrid automatic repeat request (HARQ) ACK or NACK feedback, for another example, further determine whether to perform forwarding transmission.

With reference to the second aspect, in a possible implementation, the cumulative quantity of transmission times of the first data in the first group to the N^{th} group is determined based on a cumulative quantity of groups corresponding to the first data, and the cumulative quantity of groups corresponding to the first data is N. Because the cumulative quantity of groups corresponding to the first data indicates that a small quantity of bits is occupied, overheads can be reduced.

That the cumulative quantity of transmission times of the first data in the first group to the N^{th} group is determined based on a cumulative quantity of groups corresponding to the first data may be understood as that when quantities of pieces of first data included in different groups of the N groups of data are completely the same, the cumulative quantity of transmission times of the first data in the first group to the N^{th} group is determined based on the cumulative quantity of groups corresponding to the first data.

In a possible implementation, the cumulative quantity of groups corresponding to the first data may be carried in, for example, RRC signaling or MAC signaling.

With reference to the second aspect, in a possible implementation, the method further includes: In response to time in which the second node sends an ACK to the first node overlapping time in which the second node forwards the first data to a fourth node, the second node sends second indication information to the fourth node, where the second indication information indicates a second resource used by the fourth node to forward the first data, the second resource does not include a first resource, and the first resource is used by the second node to send the ACK to the first node.

It can be learned that, to reduce a feedback delay and a forwarding delay, both sending the ACK by the second node to the first node and forwarding the first data by the second node to the fourth node are expected to be completed in the shortest time. This may cause time overlapping. When the time in which the second node sends the ACK to the first node and the time in which the second node forwards the first data to the fourth node overlap, a resource indicated by the second node to the fourth node does not include the first resource used by the second node to send the ACK to the first node. This reduces a problem of interference between feeding back the ACK and forwarding the first data. “In response to overlap of time in which the second node sends an ACK to the first node and time in which the second node forwards the first data to a fourth node” may be understood as “when the time in which the second node sends the ACK to the first node and the time in which the second node forwards the first data to the fourth node overlap”.

It should be noted that the time in which the second node sends the ACK to the first node and the time in which the second node forwards the first data to the fourth node overlap, where the overlapping may be partial overlapping or complete overlapping. This is not limited herein.

With reference to the first aspect or the second aspect, in a possible implementation, an interval between end time of transmission of the first group of data and start time of transmission of the second group of data is a first interval. This indicates that transmission between different groups is discontinuous. Even if the second node cannot receive the first group of data when sending data at a first moment, because the transmission between the different groups is discontinuous, the second node can still receive the second group of data at a second moment. In this way, it can be ensured that the second node obtains the first data in the second group of data. This can better handle randomness of a half-duplex collision problem, so that the requirement for high reliability is satisfied.

That an interval between end time of transmission of the first group of data and start time of transmission of the second group of data is a first interval may be understood as at least one of the following: An interval between end time of transmission of the K pieces of first data in the first group of data and start time of transmission of the second group of data is the first interval, an interval between a time domain position of the first group of data and a time domain position of the second group of data is the first interval, or an interval between a time domain position of the first control information and a time domain position of the second control information is the first interval.

With reference to the first aspect or the second aspect, in a possible implementation, the first interval is indicated by a third node to the first node; or the first interval is determined by the first node based on a first interval set. This improves diversity of obtaining the first interval. In addition, the first interval determined by the first node based on the first interval set can better satisfy a current quality of service (QOS) requirement of the first node for a service.

It should be noted that, in this application, the QoS requirement may include, for example, at least one of the following: a default priority value, a delay, a packet loss rate, a burst data amount, an averaging window, reliability, or the like. The service may be, for example, a high-reliability and delay-sensitive service, a broadcast service, or a service configured as grant-free transmission. This is not limited herein.

The third node indicates information about the first interval to the first node. Correspondingly, the first node receives the information that is about the first interval and that is indicated by the third node. The information about the first interval may be carried in, for example, physical (PHY) layer signaling, MAC signaling, or RRC signaling. When the information about the first interval is carried in the PHY layer signaling, a dynamic adjustment indication is implemented based on a change of a channel status.

That the first interval is determined by the first node based on a first interval set includes: The first interval is determined by the first node from the first interval set based on a first QOS requirement. The first QoS requirement is a QoS requirement of the first node for a first service. In this way, the first node can determine the first interval based on a QoS requirement of the first node.

With reference to the first aspect or the second aspect, in a possible implementation, the first interval set is indicated by the third node to the first node. It can be learned that, because the first interval set is indicated by the third node to the first node, the first interval determined by the first node based on the first interval set can better satisfy the current QoS requirement of the first node for the service.

The third node indicates information about the first interval set to the first node. Correspondingly, the first node receives the information that is about the first interval set and that is indicated by the third node. The information about the first interval set is carried in, for example, RRC signaling or MAC signaling.

In this application, for a manner of determining an interval between time domain positions of two adjacent groups of data other than the first group of data and the second group of data in the N groups of data, refer to a manner of determining the first interval. Details are not described herein again.

With reference to the first aspect or the second aspect, in a possible implementation, N is indicated by the third node to the first node; or Nis determined by the first node based on a first set of quantities of transmission times. This improves diversity of determining N. In addition, N determined by the first node based on the first set of quantities of transmission times can better satisfy the current QoS requirement of the first node for the service.

That N is determined by the first node based on a first set of quantities of transmission times includes: N is determined by the first node from the first set of quantities of transmission times based on the first QoS requirement. It should be understood that the first set of quantities of transmission times may include one or more quantities of transmission times. In this way, the first node can determine N based on a QoS requirement of the first node.

With reference to the first aspect or the second aspect, in a possible implementation, the first set of quantities of transmission times is indicated by the third node to the first node. It can be learned that, because the first set of quantities of transmission times is indicated by the third node to the first node, N determined by the first node based on the first set of quantities of transmission times can better satisfy the current QoS requirement of the first node for the service.

The third node indicates information about the first set of quantities of transmission times to the first node. Correspondingly, the first node receives the information that is about the first set of quantities of transmission times and that is indicated by the third node. The information about the first set of quantities of transmission times may be carried in, for example, MAC signaling or RRC signaling.

With reference to the first aspect or the second aspect, in a possible implementation, the first control information may include at least one of the following: path information, a quantity of transmission times of the first data corresponding to the first control information, or the first interval. The path information indicates a node through which the first node sends the first data to a destination node, and the interval between the end time of the transmission of the first group of data and the start time of the transmission of the second group of data is the first interval.

It can be learned that, because the first control information includes the path information, in a multi-hop transmission scenario, the first node can learn of a next node of the first node, so that the first data can be forwarded to the next node. In addition, because the first control information may further include the quantity of transmission times of the first data corresponding to the first control information and/or the first interval, the second node may obtain the first data in the first group of data based on the quantity of transmission times of the first data corresponding to the first control information and/or the first interval. In addition, because the path information, the quantity of transmission times of the first data corresponding to the first control information, the first interval, and the like may be included in the first control information and sent to the second node, a plurality of signaling interactions are avoided, and transmission time is reduced.

With reference to the first aspect or the second aspect, in a possible implementation, the first control information is the same as the second control information. That the first control information is the same as the second control information may be understood as at least one of the following: A payload in the first control information is the same as a payload in the second control information, an indication field in the first control information is the same as an indication field in the second control information, or a quantity of indication bits included in the first control information is the same as a quantity of indication bits included in the second control information. In this way, same detection complexity is maintained, a same configuration is supported when channel conditions are the same or similar, and different meanings, for example, different modulation and coding schemes, are indicated based on channel changes.

It should be noted that, in this application, control information included in different groups of the N groups of data may be, for example, completely the same, partially the same, or completely different. This is not limited herein. It should be understood that, when the control information included in the different groups of the N groups of data is completely the same, there is no need to configure different control information, and a configuration is simple. When the control information included in the different groups of the N groups of data is partially the same, configurations of different control information can be reduced. When the control information included in the different groups of the N groups of data is completely different, the control information may indicate transmission of the first data. This indicates that the control information included in the different groups of the N groups of data has completely different indications for transmission of the first data, so that the randomness of the half-duplex collision problem can be better handled. In this way, the requirement for high reliability is satisfied.

According to a third aspect, a communication method is provided, including: A first node determines a first time unit and a second time unit, where a first time subunit in the first time unit is used for transmission of SL data, and a second time subunit in the second time unit is a reserved resource; and the first node sends first configuration information to a second node, where the first configuration information includes at least one of the following: an index of the first time unit, an index of the first time subunit, an index of the second time unit, or an index of the second time subunit.

This indicates that the first node indicates a resource to the second node in a level-based indication manner. To be specific, not only the index of the first time unit and the index of the second time unit are indicated, but also the index of the first time subunit in the first time unit and the index of the second time subunit in the second time unit are indicated. In this way, the second node can learn of a time subunit that is in a time unit and that is used for transmission of the SL data, and learn of a time subunit that is in a time unit and that is the reserved resource. In addition, a problem of excessively high overheads caused because indexes of time subunits in all time units need to be indicated to the second node without level-based indication can be avoided. In addition, the second node may receive the SL data based on the time subunit, the index of the first time unit, and the index of the first time subunit, so that a requirement for a low delay is satisfied.

In a possible implementation, the time unit may be a slot, and the time subunit may be a subslot. For example, the first time unit may be a first slot, the first time subunit may be a first subslot, the second time unit may be a second slot, and the second time subunit may be a second subslot. The first time subunit is used for transmission of the SL data. In other words, the first subslot is used for transmission of the SL data. This indicates that this solution can support the subslot-based transmission, so that the requirement for a low delay can be satisfied.

With reference to the third aspect, in a possible implementation, the first time unit and the second time unit are included in second configuration information, and the second configuration information is indicated by a third node to the first node. This indicates that the first time unit and the second time unit may be indicated by the third node to the first node, so that the first node does not need to determine the first time unit or the second time unit.

With reference to the third aspect, in a possible implementation, the first node is an intermediate node on a transmission path of the second configuration information, and the third node is a network device or a source node on the transmission path. This indicates that the second configuration information may be indicated, to the first node, by the network device or the source node on the transmission path, so that the first node does not need to determine the first time unit or the second time unit.

With reference to the third aspect, in a possible implementation, the second configuration information is transmitted hop by hop on the transmission path. In this way, any node on the transmission path of the second configuration information can obtain the second configuration information.

According to a fourth aspect, a communication method is provided, including: A second node receives first configuration information sent by a first node, where the first configuration information includes at least one of the following: an index of a first time unit, an index of a first time subunit in the first time unit, an index of a second time unit or an index of a second time subunit in the second time unit, the first time subunit is used for transmission of SL data, and the second time subunit is a reserved resource; and the second node receives the SL data based on the index of the first time unit and the index of the first time subunit.

This indicates that the first node indicates a resource to the second node in a level-based indication manner. In this way, the second node can learn of a time subunit that is in a time unit and that is used for transmission of the SL data, and learn of a time subunit that is in a time unit and that is the reserved resource. In addition, a problem of excessively high overheads caused because indexes of time subunits in all time units need to be indicated to the second node without level-based indication can be avoided. In addition, the second node may receive the SL data based on the time subunit, the index of the first time unit, and the index of the first time subunit, so that a requirement for a low delay is satisfied.

With reference to the third aspect or the fourth aspect, in a possible implementation, time subunits in the first time unit and time subunits in the second time unit are jointly numbered. That time subunits in the first time unit and time subunits in the second time unit are jointly numbered may be understood as, for example, that the first node numbers the time subunits in the first time unit and the time subunits in the second time unit in a time sequence. Joint numbering helps reduce signaling indication overheads, and may further enable indexes of the time subunits in the first time unit and the second time unit to be different.

With reference to the third aspect or the fourth aspect, in a possible implementation, the time subunits in the first time unit and the time subunits in the second time unit are independently numbered. That the time subunits in the first time unit and the time subunits in the second time unit are independently numbered may be understood as, for example, that the first node numbers the time subunits in the first time unit in the time sequence, and numbers the time subunits in the second time unit in the time sequence. In this way, the index of the time subunit in the first time unit and the index of the time subunit in the second time unit are not particularly large, and each quantity of bits that is separately indicated by the first node is fixed during indication, regardless of whether there is a configuration of another unit or a quantity of configurations of other units.

According to a fifth aspect, a communication method is provided, including: A first node generates first information, where the first information indicates one or more subslot length sets supported by a second node, and one subslot length set includes one or more subslot lengths; and the first node sends the first information to the second node. It can be learned that, because the first information indicates the one or more subslot length sets supported by the second node, and one subslot length set includes one or more subslot lengths, different subslot lengths are provided for the second node. In this way, the second node can select an appropriate subslot length with reference to QoS requirements of different services, to better satisfy requirements for a low delay and high reliability in the QoS requirements.

With reference to the fifth aspect, in a possible implementation, that the first information indicates one or more subslot length sets supported by a second node includes: The first information indicates one or more subslot length sets supported by a first group of nodes, and the first group of nodes includes the second node. It can be learned that the first information may indicate one or more subslot length sets supported by a group of nodes. This is equivalent to performing system-level or cell-level configuration, and a system transmission efficiency requirement is satisfied.

In a possible implementation, the one or more subslot length sets supported by the first group of nodes may be determined by a third node based on a first QOS requirement of the first group of nodes, where the first QoS requirement is a QoS requirement of the one or more nodes in the first group of nodes for different services. For example, the first QoS requirement may be preconfigured in the third node, or may be received from the first group of nodes. For example, a minimum subslot length in one subslot length set is determined based on a highest delay requirement of the first group of nodes. For another example, a maximum subslot length in one subslot length set is determined based on a lowest delay requirement of the first group of nodes.

With reference to the fifth aspect, in a possible implementation, the method further includes: The first node sends second information to the first group of nodes, where the second information indicates that a subslot length set available to the first group of nodes at a first moment is a first subslot length set and a subslot length set available to the first group of nodes at a second moment is a second subslot length set, the first subslot length set and the second subslot length set are subslot length sets supported by the first group of nodes, and the first subslot length set and the second subslot length set are different. This indicates that subslot length sets available to the first group of nodes at different moments are different, so that QoS requirements of the first group of nodes for different services at the different moments can be satisfied.

According to a sixth aspect, a communication method is provided, including: A second node receives first information sent by a first node, where the first information indicates one or more subslot length sets supported by the second node, and one subslot length set includes one or more subslot lengths; and the second node determines a first subslot length based on the one or more subslot length sets. This provides different subslot lengths for the second node, so that the second node can select an appropriate subslot length with reference to QoS requirements of different services, to better satisfy requirements for a low delay and high reliability in the QoS requirements.

With reference to the fifth aspect or the sixth aspect, in a possible implementation, another subslot length in a plurality of subslot lengths is in a multiple relationship with a minimum subslot length, and the another subslot length is a subslot length other than the minimum subslot length in the plurality of subslot lengths. It can be learned that, because the another subslot length in the plurality of subslot lengths is in the multiple relationship with the minimum subslot length, and a control channel is on the 1^{st} symbol of a subslot, a quantity of blind detection times can be reduced when blind detection is performed on control channels carried in the subslots in the multiple relationship.

With reference to the sixth aspect, in a possible implementation, that the first information indicates one or more subslot length sets supported by the second node includes: The first information indicates one or more subslot length sets supported by a first group of nodes, and the first group of nodes includes the second node. It can be learned that the first information may indicate one or more subslot length sets supported by a group of nodes. This is equivalent to performing system-level or cell-level configuration, and a system transmission efficiency requirement is satisfied.

With reference to the fifth aspect, in a possible implementation, a third subslot length set and a fourth subslot length set are subslot length sets supported by the first group of nodes and a second group of nodes, the second group of nodes includes one or more nodes, and the method further includes: The first node sends third information to the first group of nodes, where the third information indicates that a subslot length set available to the first group of nodes is the third subslot length set; and the first node sends fourth information to the second group of nodes, where the fourth information indicates that a subslot length set available to the second group of nodes is the fourth subslot length set. The third subslot length set and the fourth subslot length set are different. This indicates that subslot length sets available to nodes in different groups are different, so that QoS requirements of the nodes in the different groups for different services can be satisfied.

According to a seventh aspect, a communication method is provided, including: A first node determines a first time unit and a second time unit, where a first time subunit in the first time unit is used for transmission of SL data, and a second time subunit in the second time unit is a reserved resource; and when the first time subunit and the second time subunit are within a length range that is configured by the first node and that includes a plurality of time subunits, the first node sends third configuration information to a second node, where the third configuration information includes at least one of the following: an index of the first time subunit or an index of the second time subunit.

This indicates that when the first time subunit and the second time subunit are within the length range that is configured by the first node and that includes the plurality of time subunits, the first node may directly indicate the index of the time subunit to the second node, so that overheads are reduced. In addition, the second node can learn of a time subunit that is used for transmission of the SL data, and learn of a time subunit that is the reserved resource.

According to an eighth aspect, a communication method is provided, including: A second node receives third configuration information sent by a first node, where the third configuration information includes at least one of the following: an index of a first time subunit and an index of a second time subunit, the first time subunit is used for transmission of SL data, or the second time subunit is a reserved resource; and the second node receives the SL data based on the index of the first time subunit.

This indicates that when the first time subunit and the second time subunit are within a length range that is configured by the first node and that includes a plurality of time subunits, the first node may directly indicate the index of the time subunit to the second node, so that overheads are reduced. In addition, the second node can learn of a time subunit that is used for transmission of the SL data, and learn of a time subunit that is the reserved resource.

According to a ninth aspect, a communication apparatus is provided. The communication apparatus may be a first node, a second node, or a third node, may be an apparatus in the first node, the second node, or the third node, or may be an apparatus that can be used together with the first node, the second node, or the third node. The communication apparatus may alternatively be a chip system, including a module configured to perform the method according to any one of the first aspect to the eighth aspect. Functions of the communication apparatus may be implemented by hardware, or may be implemented by hardware executing corresponding software. The hardware or the software includes one or more modules corresponding to the functions. The module may be software and/or hardware.

According to a tenth aspect, a communication apparatus is provided, including a processor coupled to a memory, where the processor is configured to execute a computer program or instructions stored in the memory, to implement the method according to any one of the first aspect to the eighth aspect.

In a possible implementation, the communication apparatus further includes the memory, and the memory and the processor are coupled to each other. In a possible implementation, the memory and the processor are integrated together.

In a possible implementation, the communication apparatus further includes a transceiver, and the transceiver is configured to receive and send data and/or signaling.

According to an eleventh aspect, a communication apparatus is provided, including a processor and an interface circuit. The interface circuit is configured to: receive a signal from a communication apparatus other than the communication apparatus and transmit the signal to the processor, or send a signal from the processor to a communication apparatus other than the communication apparatus, and the processor is configured to implement, by using a logic circuit or executing instructions, the method according to any one of the first aspect to the eighth aspect.

According to a twelfth aspect, a computer-readable storage medium is provided, where the storage medium stores a computer program or instructions, and when the computer program or the instructions are executed by a communication apparatus, the method according to any one of the first aspect to the eighth aspect is performed.

According to a thirteenth aspect, a computer program product including instructions is provided, and when the computer program product runs on a computer, the method according to any one of the first aspect to the eighth aspect is performed.

According to a fourteenth aspect, a communication system is provided, where the communication system includes a first node configured to perform the method according to any one of the first aspect, the third aspect, the fifth aspect, or the seventh aspect, and a second node configured to perform the method according to any one of the second aspect, the fourth aspect, the sixth aspect, or the eighth aspect.

### BRIEF DESCRIPTION OF DRAWINGS

The following briefly describes accompanying drawings used for describing embodiments.

FIG. 1 shows a basic architecture of a communication system according to an embodiment of this application;

FIG. 2 shows a basic architecture of a communication system in a multi-hop transmission scenario according to an embodiment of this application;

FIG. 3 is a diagram of a hardware structure of a communication apparatus according to an embodiment of this application;

FIG. 4 is a diagram of interaction of a communication method according to an embodiment of this application;

FIG. 5 shows distribution of a plurality of groups of data in time domain according to an embodiment of this application;

FIG. 6 shows other distribution of a plurality of groups of data in time domain according to an embodiment of this application;

FIG. 7 is a diagram of interaction of another communication method according to an embodiment of this application;

FIG. 8 is a diagram of joint numbering according to an embodiment of this application;

FIG. 9 is a diagram of independent numbering according to an embodiment of this application;

FIG. 10 is a diagram of performing blind detection on a control channel according to an embodiment of this application;

FIG. 11 is a diagram of interaction of another communication method according to an embodiment of this application;

FIG. 12 is a diagram of interaction of another communication method according to an embodiment of this application;

FIG. 13 is a diagram of a structure of a communication apparatus according to an embodiment of this application;

FIG. 14 is a diagram of a structure of a simplified terminal device according to an embodiment of this application; and

FIG. 15 is a diagram of a structure of a simplified network device according to an embodiment of this application.

### DESCRIPTION OF EMBODIMENTS

The following describes the technical solutions in embodiments of this application with reference to accompanying drawings in embodiments of this application. The terms “system” and “network” may be used interchangeably in embodiments of this application. “/” represents an “or” relationship between associated objects unless otherwise specified. For example, A/B may represent A or B. The term “and/or” in this application is merely an association relationship for describing associated objects, and represents that three relationships may exist. For example, A and/or B may represent the following three cases: Only A exists, both A and B exist, and only B exists, where A and B each may be singular or plural. In addition, in the descriptions of this application, “a plurality of” means two or more than two unless otherwise specified. “At least one of the following items (pieces)” or a similar expression thereof means any combination of these items, including any combination of singular items (pieces) or plural items (pieces). For example, at least one of a, b, or c may represent a, b, c, a and b, a and c, b and c, or a, b, and c, where a, b, and c may be singular or plural. In addition, to clearly describe the technical solutions in embodiments of this application, terms such as “first” and “second” are used in embodiments of this application to distinguish between same items or similar items that provide basically same functions or purposes. A person skilled in the art may understand that the terms such as “first” and “second” do not limit a quantity or an execution sequence, and the terms such as “first” and “second” do not indicate a definite difference.

Reference to “an embodiment”, “some embodiments”, or the like described in embodiments of this application indicates that one or more embodiments of this application include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “comprise”, “have”, and their variants all mean “include but are not limited to”, unless otherwise specifically emphasized in another manner. In the following specific implementations, objectives, technical solutions, and beneficial effects of this application are further described in detail. It should be understood that the following descriptions are merely specific implementations of this application, but are not intended to limit the protection scope of this application. Any modification, equivalent replacement, improvement, or the like made based on the technical solutions of this application shall fall within the protection scope of this application.

In embodiments of this application, unless otherwise stated or there is a logic conflict, terms and/or descriptions between different embodiments are consistent and may be mutually referenced, and technical features in different embodiments may be combined into a new embodiment based on an internal logical relationship thereof.

The following describes some terms involved in this application.

### 1. Node (Node)

In this application, the node is an electronic device having a communication capability, and is also referred to as a communication node.

In a multi-hop transmission scenario, nodes may be classified into a source node, an intermediate node, a destination node, and a scheduling node. The source node is a source node that generates signaling, data, or information on a transmission path. The intermediate node is a node that forwards the signaling, the data, or the information on the transmission path. The destination node is a destination node that receives the signaling, the data, or the information on the transmission path. The scheduling node is a node that generates the signaling, and may be the source node or another node.

In a possible implementation, there may be one or more intermediate nodes.

It should be noted that, in this application, in a possible implementation, the source node, the intermediate node, the destination node, and the scheduling node may be terminal devices. In another possible implementation, the source node and the scheduling node may be network devices, and the intermediate node and the destination node may be terminal devices.

The terminal device in this application is an entity that is on a user side and that is configured to: receive a signal, send a signal, or receive a signal and send a signal. The terminal device may be configured to provide one or more of a voice service and a data connectivity service for a user. The terminal device may be a device that includes a wireless transceiver function and that can cooperate with the network device to provide a communication service for the user. Specifically, the terminal device may refer to user equipment (UE), an access terminal, a subscriber unit, a subscriber station, a mobile station, a remote station, a remote terminal, a mobile device, a terminal, a wireless communication device, a user agent, a user apparatus, or a road side unit (RSU). Alternatively, the terminal device may be an unmanned aerial vehicle, an internet of things (IoT) device, a station (ST) in a WLAN, a cellular phone (cellular phone), a smartphone (smartphone), a cordless phone, a wireless data card, a tablet computer, a session initiation protocol (SIP) phone, a wireless local loop (WLL) station, a personal digital assistant (PDA) device, a laptop computer (laptop computer), a machine type communication (MTC) terminal, a handheld device having a wireless communication function, a computing device or another processing device connected to a wireless modem, a vehicle-mounted device, a satellite terminal, a smart point of sale (POS) machine, customer-premises equipment (CPE), a wearable device (which may also be referred to as a wearable smart device), a virtual reality (VR) terminal, an augmented reality (AR) terminal, a wireless terminal in industrial control (industrial control), a wireless terminal in self driving (self driving), a wireless terminal in telemedicine (telemedicine), a wireless terminal in a smart grid (smart grid), a wireless terminal in transportation safety (transportation safety), a wireless terminal in a smart city (smart city), a wireless terminal in a smart home (smart home), and the like. Alternatively, the terminal device may be a D2D device, for example, an electricity meter or a water meter. Alternatively, the terminal device may be a terminal in a 5G system, or a terminal in a next-generation communication system. This is not limited in embodiments of this application.

The network device in this application is an entity that is on a network side and that is configured to: send a signal, receive a signal, or send a signal and receive a signal. The network device may be an apparatus that is deployed in a radio access network (RAN) and that provides a wireless communication function for the terminal device, for example, may be a transmission reception point (TRP), a base station, or a control node in various forms, for example, a network controller, a radio controller, or a radio controller in a cloud radio access network (CRAN) scenario. Specifically, the network device may be a macro base station, a micro base station (also referred to as a small cell), a relay station, an access point (AP), a home base station (for example, a home evolved NodeB or a home NodeB, HNB), a baseband unit (BBU), a transmission point (TP), a mobile switching center, a satellite, an unmanned aerial vehicle, or the like in various forms, or may be an antenna panel of a base station. The control node may be connected to a plurality of base stations, and configure resources for a plurality of terminals covered by the plurality of base stations. In systems using different radio access technologies, names of devices having a base station function may be different. For example, the network device may be a gNB in 5G, a network side device in a network after the 5G, an access network device in a public land mobile (communication) network (PLMN) evolved after the 5G, a device that undertakes a base station function in device-to-device (D2D) communication, machine-to-machine (M2M) communication, or internet of vehicles communication, or the like, or may be a network device in a non-terrestrial network (NTN) communication system, that is, may be deployed on a high-altitude platform or a satellite. A specific name of the access network device is not limited in this application. In addition, the network device may further include a distributed unit (DU) and a central unit (CU).

### 2. SL or Super Sidelink (SSL)

The SL is defined for direct communication between terminal devices. To be specific, the SL is a link on which the terminal devices directly communicate with each other without forwarding by a base station. An interface between the terminal devices may be referred to as a PC5 interface.

A communication manner of the SL is a half-duplex communication manner. Half-duplex means that both communication parties have functions of sending and receiving data, and can only send or receive the data at a same moment.

In this application, the SL may be, for example, an SSL, and the SSL is enhancement of the SL.

### 3. Time Unit

The time unit may be, for example, a time unit with a different time granularity such as a frame, a subframe, a slot, a subslot, a mini-slot, or a symbol. The symbol may also be referred to as an orthogonal frequency division multiplexing (OFDM) symbol.

In a new radio (NR) standard, duration of the frame is 10 ms, each frame is divided into 10 subframes, and a length of each subframe is 1 ms. Each subframe is divided into several slots (slots). When a cyclic prefix (CP) is a normal (normal) CP, each slot includes 14 symbols. When a cyclic prefix is an extended (extended) CP, each slot includes 12 symbols. A specific time length of each slot is determined by a parameter set. The parameter set may include, for example, a subcarrier spacing (SCS). For example, when the SCS is 15 kHz, a length of one slot is 1 ms. When the subcarrier spacing is 30 kHz, a length of one slot is 0.5 ms. It is clear that, with evolution of communication technologies, a time length of one subframe may alternatively be another value, and a quantity of symbols included in one slot may alternatively be another value. This is not limited in this application. In NR, the subslot or the mini-slot is defined as a possible minimum scheduling unit. The subslot or the mini-slot may start from any symbol of a slot and end at any symbol of a slot. For example, a small quantity of symbols (for example, 2 to 13 symbols of the normal CP or 3 to 12 symbols of the extended CP) is configured in the slot to support subslot or mini-slot transmission.

The foregoing content briefly describes meanings of some terms in embodiments of this application. To better understand the technical solutions provided in embodiments of this application, the foregoing content does not constitute a limitation on the technical solutions provided in embodiments of this application.

It should be understood that the technical solutions in embodiments of this application may be applied to a long term evolution (LTE) system, a 5th generation (5G) mobile communication system, a wireless local area network (WLAN) system, a V2X communication system, and the like. The technical solutions in embodiments of this application may be further applied to a communication system evolved after the 5G, for example, a 6G communication system. A same function may be maintained, but a name may be changed.

The following describes a basic architecture of a communication system according to embodiments of this application.

FIG. 1 shows a basic architecture of a communication system according to an embodiment of this application. As shown in FIG. 1, the communication system may include one or more network devices 10 (where only one network device is shown in FIG. 1) and one or more terminal devices, for example, a terminal device 20 and a terminal device 30 in FIG. 1, that communicate with the network device. The terminal device 20 and the terminal device 30 may perform SL communication. This is not limited herein. FIG. 1 is merely a diagram, and does not constitute a limitation on a scenario to which the technical solutions provided in this application are applicable.

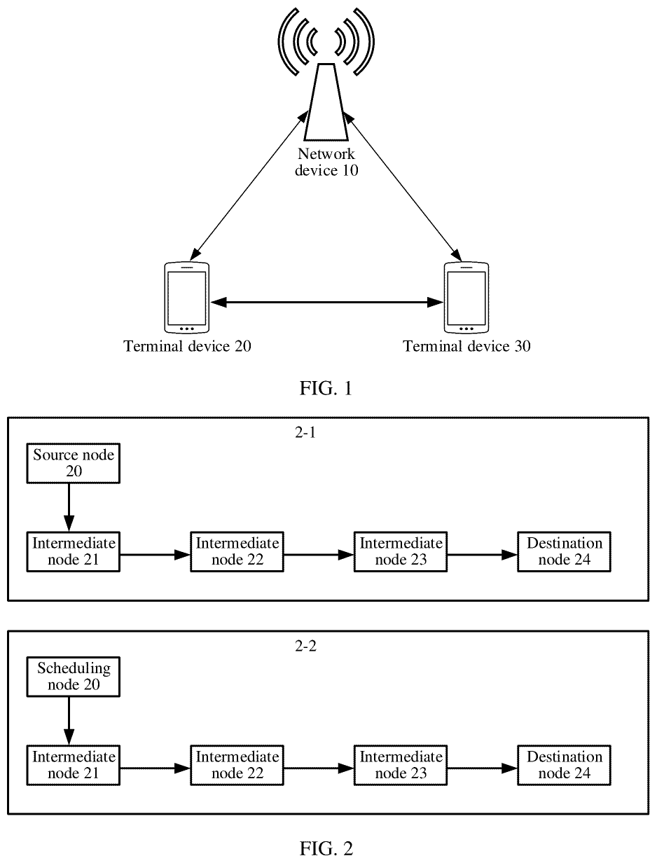

FIG. 2 shows a basic architecture of a communication system in a multi-hop transmission scenario according to an embodiment of this application. In 2-1 in FIG. 2, the communication system includes a source node 20, one or more intermediate nodes (for example, an intermediate node 21, an intermediate node 22, and an intermediate node 23 in FIG. 2), and a destination node 24. It should be understood that the source node 20 may send signaling, data, or information to the intermediate node 21, the intermediate node 21 may send the signaling, the data, or the information to the intermediate node 22, the intermediate node 22 may send the signaling, the data, or the information to the intermediate node 23, and the intermediate node 23 may send the signaling, the data, or the information to the destination node 24. In 2-2 in FIG. 2, the communication system includes a scheduling node 20, one or more intermediate nodes (for example, an intermediate node 21, an intermediate node 22, and an intermediate node 23 in FIG. 2), and a destination node 24. It should be understood that the scheduling node 20 may send signaling, data, or information to the intermediate node 21, the intermediate node 21 may send the signaling, the data, or the information to the intermediate node 22, the intermediate node 22 may send the signaling, the data, or the information to the intermediate node 23, and the intermediate node 23 may send the signaling, the data, or the information to the destination node 24.

It should be noted that the technical solutions provided in embodiments of this application are applicable to a plurality of system architectures. A network architecture and a service scenario described in embodiments of this application are intended to describe the technical solutions in embodiments of this application more clearly, and do not constitute a limitation on the technical solutions provided in embodiments of this application. A person of ordinary skill in the art may know that, with evolution of the network architecture and emergence of new service scenarios, the technical solutions provided in embodiments of this application are also applicable to similar technical problems.

In a possible implementation, each device in FIG. 1 or FIG. 2 may be implemented by one device, may be jointly implemented by a plurality of devices, or may be one functional module in one device. This is not specifically limited in embodiments of this application. It may be understood that the foregoing function may be a network element in a hardware device, a software function running on dedicated hardware, or a virtualization function instantiated on a platform (for example, a cloud platform).

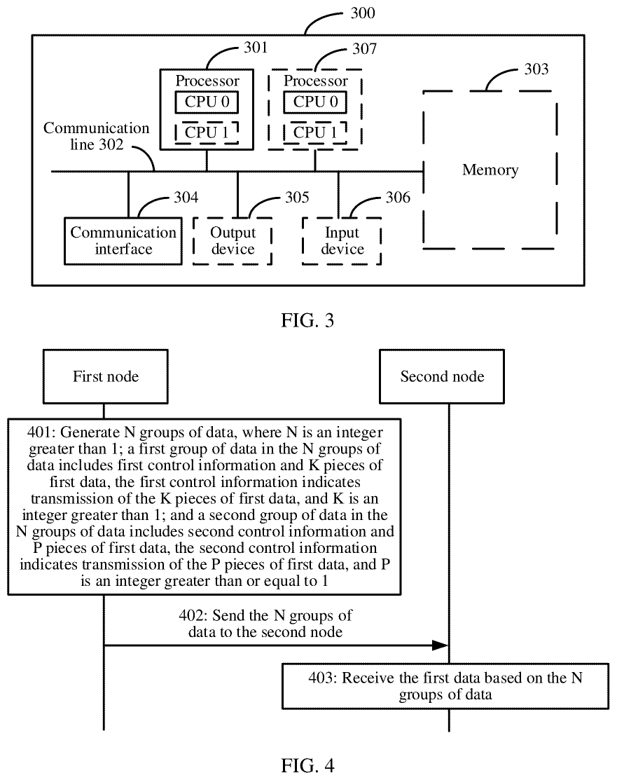

For example, each device in FIG. 1 or FIG. 2 may be implemented by using a communication apparatus 300 in FIG. 3. FIG. 3 is a diagram of a hardware structure of a communication apparatus according to an embodiment of this application. The communication apparatus 300 includes at least one processor 301, a communication line 302, and at least one communication interface 304. In a possible implementation, the communication apparatus 300 includes a memory 303.

The processor 301 may be a general-purpose central processing unit (CPU), a microprocessor, an application-specific integrated circuit (ASIC), or one or more integrated circuits configured to control program execution of the solutions of this application.

The communication line 302 may include a path for information transmission between the foregoing components.

The communication interface 304 is an apparatus (for example, an antenna) of any transceiver type, and is configured to communicate with another device or a communication network. The communication network may be, for example, an Ethernet, a RAN, or a WLAN.

The memory 303 may be a read-only memory (ROM), another type of static storage device that can store static information and instructions, a random access memory (RAM), or another type of dynamic storage device that can store information and instructions; or may be an electrically erasable programmable read-only memory (EEPROM), a compact disc read-only memory (CD-ROM) or another compact disc storage, an optical disc storage (including a compact optical disc, a laser disc, an optical disc, a digital versatile disc, a Blu-ray optical disc, or the like), a magnetic disk storage medium or another magnetic storage device, or any other medium that can carry or store expected program code in a form of an instruction or a data structure and that can be accessed by a computer, but is not limited thereto. The memory may exist independently, and is connected to the processor through the communication line 302. The memory may alternatively be integrated with the processor. The memory provided in embodiments of this application may be usually non-volatile.

The memory 303 is configured to store computer-executable instructions for performing the solutions of this application, and the processor 301 controls execution. The processor 301 is configured to execute the computer-executable instructions stored in the memory 303, to implement methods provided in the following embodiments of this application.

In a possible implementation, the computer-executable instructions in embodiments of this application may also be referred to as application program code. This is not specifically limited in embodiments of this application.

In a possible implementation, the processor 301 may include one or more CPUs, for example, a CPU 0 and a CPU 1 in FIG. 3.

In a possible implementation, the communication apparatus 300 may include a plurality of processors, for example, the processor 301 and a processor 307 in FIG. 3. Each of the processors may be a single-core (single-CPU) processor, or may be a multi-core (multi-CPU) processor. The processor herein may be one or more devices, circuits, and/or processing cores configured to process data (for example, computer program instructions).

In a possible implementation, the communication apparatus 300 may further include an output device 305 and an input device 306. The output device 305 communicates with the processor 301, and may display information in a plurality of manners. For example, the output device 305 may be a liquid crystal display (LCD), a light emitting diode (LED) display device, a cathode ray tube (CRT) display device, a projector (projector), or the like. The input device 306 communicates with the processor 301, and may receive an input of a user in a plurality of manners. For example, the input device 306 may be a mouse, a keyboard, a touchscreen device, a sensor device, or the like.

The foregoing communication apparatus 300 may be a general-purpose device or a dedicated device. During specific implementation, the communication apparatus 300 may be any one of the foregoing terminals or network devices. A type of the communication apparatus 300 is not limited in embodiments of this application.

The following describes the solutions with reference to the accompanying drawings.

A typical communication manner of an SL is a half-duplex communication manner. This means that when sending data, a terminal device cannot receive data sent by another terminal device, or when receiving data, a terminal device cannot send data to another terminal device. In other words, the half-duplex communication manner cannot satisfy a requirement for high reliability. To resolve this problem, refer to FIG. 4. FIG. 4 is a diagram of interaction of a communication method according to an embodiment of this application. A first node, a second node, or a fourth node in the embodiment in FIG. 4 may be, for example, the terminal device in FIG. 1, and a third node in the embodiment in FIG. 4 may be, for example, the network device or the terminal device in FIG. 1. Alternatively, a first node, a second node, or a fourth node in the embodiment in FIG. 4 may be, for example, the intermediate node in FIG. 2, and a third node in the embodiment in FIG. 4 may be, for example, the source node or the scheduling node in FIG. 2. The method includes but is not limited to the following steps.

401: The first node generates N groups of data, where N is an integer greater than 1; a first group of data in the N groups of data includes first control information and K pieces of first data, the first control information indicates transmission of the K pieces of first data, and K is an integer greater than 1; and a second group of data in the N groups of data includes second control information and P pieces of first data, the second control information indicates transmission of the P pieces of first data, and P is an integer greater than or equal to 1.

It should be noted that, in this application, content included in a group of data other than the first group of data and the second group of data in the N groups of data is similar to content included in the first group of data or the second group of data. In other words, each of the N groups of data includes one piece of control information and at least one piece of first data. This facilitates self-decoding of each group of data. In a possible implementation, in this application, first data included in different groups of the N groups of data is same data.

In this application, quantities of pieces of first data included in the different groups of the N groups of data may be completely the same, partially the same, or completely different. This is not limited herein. It should be understood that, when the quantities of pieces of first data included in the different groups of the N groups of data are completely the same, there is no need to configure different quantities, and a configuration is simple. When the quantities of pieces of first data included in the different groups of the N groups of data are partially the same, configurations of different quantities can be reduced. When the quantities of pieces of first data included in the different groups of the N groups of data are completely different, a dynamic change of a channel and randomness of a half-duplex collision problem can be better handled. In this way, a requirement for high reliability is satisfied.

For example, three groups of data are respectively a group 1, a group 2, and a group 3. For example, the group 1, the group 2, and the group 3 may each include three pieces of first data. In other words, quantities of pieces of first data included in different groups of the three groups of data are completely the same. For another example, the group 1 and the group 2 may each include three pieces of first data, and the group 3 includes five pieces of first data. In other words, quantities of pieces of first data included in the group 1 and the group 2 in the three groups of data are the same. In other words, quantities of pieces of first data included in different groups of the three groups of data are partially the same. For another example, the group 1 may include three pieces of first data, the group 2 may include four pieces of first data, and the group 3 includes five pieces of first data. In other words, quantities of pieces of first data included in different groups of the three groups of data are completely different.

It should be noted that, when the quantities of pieces of first data included in the different groups of the N groups of data are completely the same, a quantity of pieces of first data included in any one of the N groups of data is greater than 1. In this way, a problem that data cannot be simultaneously sent and received due to half-duplex can be well resolved, so that a specific guarantee can be provided for a receiver to obtain the first data, and the requirement for high reliability can be satisfied.

In a possible implementation, different groups of the N groups of data have different time domain positions. Specifically, a time domain position of control information included in a same group of the N groups of data may be, for example, before a time domain position of first data in the group. For example, a time domain position of the first control information is before time domain positions of the K pieces of first data, and a time domain position of the second control information is before time domain positions of the P pieces of first data. This indicates that the first node sends the N groups of data to the second node at different time. In addition, the first data included in the same group of the N groups of data may be repeatedly sent to the second node for a plurality of times on different time-frequency resources, so that a plurality of times of inter-group sending are implemented, and the first data in the group is sent for a plurality of times. Reliability of intra-group transmission is ensured. In addition, the randomness of the half-duplex collision problem can be better handled. In this way, the requirement for high reliability is satisfied.

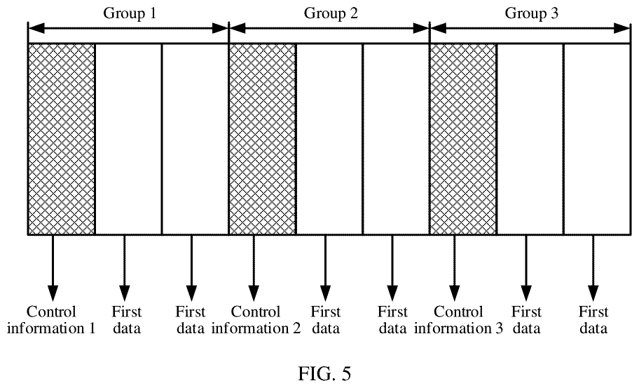

For example, FIG. 5 shows distribution of a plurality of groups of data in time domain according to an embodiment of this application. As shown in FIG. 5, three groups of data are respectively a group 1, a group 2, and a group 3. The group 1 includes control information 1 and two pieces of first data, the group 2 includes control information 2 and two pieces of first data, and the group 3 includes control information 3 and two pieces of first data. It can be learned that a time domain position of the group 1 is before a time domain position of the group 2, and the time domain position of the group 2 is before a time domain position of the group 3. In other words, different groups of the three groups of data have different time domain positions. In addition, a time domain position of the control information 1 in the group 1 is before time domain positions of the two pieces of first data in the group 1, a time domain position of the control information 2 in the group 2 is before time domain positions of the two pieces of first data in the group 2, and a time domain position of the control information 3 in the group 3 is before time domain positions of the two pieces of first data in the group 3. In other words, a time domain position of control information included in a same group of the three groups of data may be, for example, before a time domain position of first data in the group.

In a possible implementation, a time domain resource occupied by control information or first data included in any one of the N groups of data may be, for example, at least one subslot, at least one mini-slot, or at least one symbol. In other words, the first node may send the N groups of data to the second node based on a subslot granularity, a mini-slot granularity, or a symbol granularity. This can satisfy a transmission requirement for a low delay.

In a possible implementation, the first data included in the same group of the N groups of data may occupy some frequency domain resources on which the control information in the group is located. In other words, there may be no interval between the data and the control information in frequency domain, so that resource utilization is improved.

In a possible implementation, an interval between end time of transmission of the first group of data and start time of transmission of the second group of data is a first interval. This indicates that transmission between different groups is discontinuous. Even if the second node cannot receive the first group of data when sending data at a first moment, because the transmission between the different groups is discontinuous, the second node can still receive the second group of data at a second moment. In this way, it can be ensured that the second node obtains the first data in the second group of data. This can better handle the randomness of the half-duplex collision problem, so that the requirement for high reliability is satisfied.

That an interval between end time of transmission of the first group of data and start time of transmission of the second group of data is a first interval may be understood as at least one of the following: An interval between end time of transmission of the K pieces of first data in the first group of data and start time of transmission of the second group of data is the first interval, an interval between a time domain position of the first group of data and a time domain position of the second group of data is the first interval, or an interval between the time domain position of the first control information and the time domain position of the second control information is the first interval.

In a possible implementation, the first interval may be indicated by the third node to the first node; or the first interval may be determined by the first node based on a first interval set. This improves diversity of obtaining the first interval. In addition, the first interval determined by the first node based on the first interval set can better satisfy a current quality of service (QOS) requirement of the first node for a service.

It should be noted that, in this application, the QoS requirement may include, for example, at least one of the following: a default priority value, a delay, a packet loss rate, a burst data amount, an averaging window, reliability, or the like. The service may be, for example, a high-reliability and delay-sensitive service, a broadcast service, or a service configured as grant-free transmission. This is not limited herein.

The third node indicates information about the first interval to the first node. Correspondingly, the first node receives the information that is about the first interval and that is indicated by the third node. The information about the first interval may be carried in, for example, physical PHY layer signaling, MAC signaling, or RRC signaling. When the information about the first interval is carried in the PHY layer signaling, a dynamic adjustment indication is implemented based on a change of a channel status.

That the first interval may be determined by the first node based on a first interval set includes: The first interval is determined by the first node from the first interval set based on a first QoS requirement. The first QoS requirement is a QoS requirement of the first node for a first service. In this way, the first node can determine the first interval based on the QoS requirement of the first node.

For example, the first interval set may be, for example, {2, 4}, and a length of the first interval may be, for example, two subslots or four subslots.

In a possible implementation, the first interval set may be indicated by the third node to the first node. It can be learned that, because the first interval set is indicated by the third node to the first node, the first interval determined by the first node based on the first interval set can better satisfy the current QoS requirement of the first node for the service.

The third node indicates information about the first interval set to the first node. Correspondingly, the first node receives the information that is about the first interval set and that is indicated by the third node. The information about the first interval set is carried in, for example, RRC signaling or MAC signaling.

In this application, for a manner of determining an interval between time domain positions of two adjacent groups of data other than the first group of data and the second group of data in the N groups of data, refer to a manner of determining the first interval. Details are not described herein again.

In a possible implementation, intervals between time domain positions of every two adjacent groups of data in the N groups of data may be completely the same, partially the same, or completely different. This is not limited herein. It should be understood that, when the intervals between the time domain positions of the every two adjacent groups of data in the N groups of data are completely the same, there is no need to configure different intervals, and a configuration is simple, so that overheads can be reduced. When the intervals between the time domain positions of the every two adjacent groups of data in the N groups of data are partially the same, configurations of different intervals can be reduced. When the intervals between the time domain positions of the every two adjacent groups of data in the N groups of data are completely different, flexibility is high, so that the randomness of the half-duplex collision problem can be better handled. In this way, the requirement for high reliability is satisfied. In addition, the overheads, the self-decoding, and the problem that receiving and sending are not performed simultaneously due to the half-duplex can be better balanced, so that better performance in terms of the reliability and the overheads is achieved.

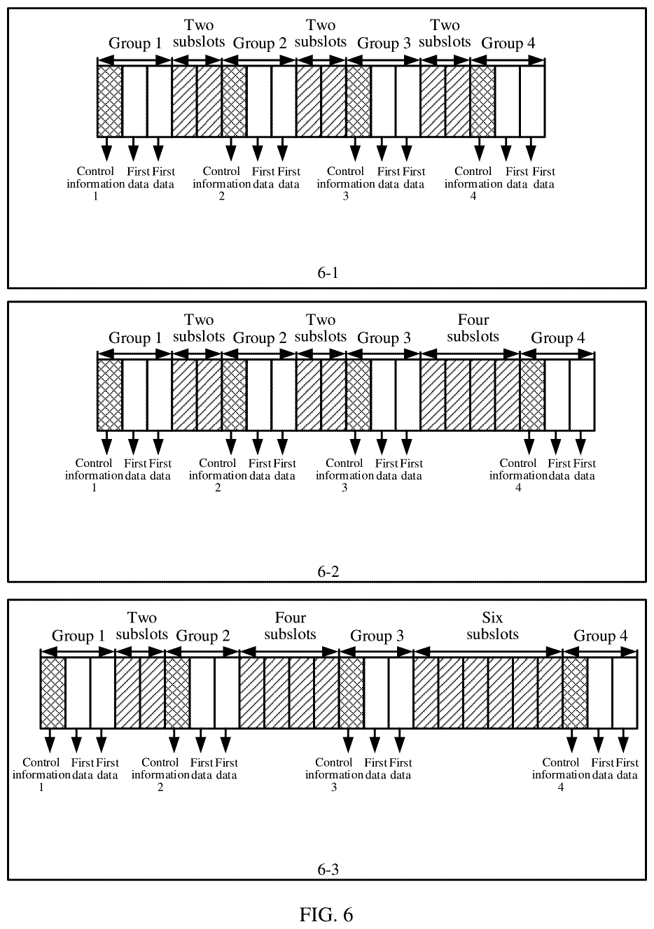

For example, FIG. 6 shows other distribution of a plurality of groups of data in time domain according to an embodiment of this application. As shown in FIG. 6, four groups of data are respectively a group 1, a group 2, a group 3, and a group 4. The group 1 and the group 2 are adjacent in time domain positions, the group 2 and the group 3 are adjacent in time domain positions, and the group 3 and the group 4 are adjacent in time domain positions. The group 1 includes control information 1 and two pieces of first data, the group 2 includes control information 2 and two pieces of first data, the group 3 includes control information 3 and two pieces of first data, and the group 4 includes control information 4 and two pieces of first data. As shown in 6-1 in FIG. 6, an interval between the time domain position of the group 1 and the time domain position of the group 2 is two subslots, an interval between the time domain position of the group 2 and the time domain position of the group 3 is two subslots, and an interval between the time domain position of the group 3 and the time domain position of the group 4 is two subslots. In other words, intervals between time domain positions of every two adjacent groups of data in the four groups of data are completely the same. For another example, as shown in 6-2 in FIG. 6, an interval between the time domain position of the group 1 and the time domain position of the group 2 is two subslots, an interval between the time domain position of the group 2 and the time domain position of the group 3 is two subslots, and an interval between the time domain position of the group 3 and the time domain position of the group 4 is four subslots. In other words, intervals between time domain positions of every two adjacent groups of data in the four groups of data are partially the same. For another example, as shown in 6-3 in FIG. 6, an interval between the time domain position of the group 1 and the time domain position of the group 2 is two subslots, an interval between the time domain position of the group 2 and the time domain position of the group 3 is four subslots, and an interval between the time domain position of the group 3 and the time domain position of the group 4 is six subslots. In other words, intervals between time domain positions of every two adjacent groups of data in the four groups of data are completely different.

It should be noted that an interval between time domain positions of two adjacent groups of data in the N groups of data may be, for example, a multiple of a length of a preset time unit. The preset time unit may be, for example, a time unit with a different time granularity such as a frame, a subframe, a slot, a subslot, a mini-slot, or a symbol. For example, the interval between the time domain positions of the two adjacent groups of data in the N groups of data may be two subslots, four subslots, or the like. In this way, an interval between time domain positions of control information included in the two adjacent groups of data in the N groups of data may be a multiple of the length of the preset time unit, so that a quantity of blind detection times can be reduced when blind detection is performed on control information in each group of data.

In a possible implementation, N is indicated by the third node to the first node; or Nis determined by the first node based on a first set of quantities of transmission times. This improves diversity of determining N. In addition, N determined by the first node based on the first set of quantities of transmission times can better satisfy a current QoS requirement of the first node for a service.

That N is determined by the first node based on a first set of quantities of transmission times includes: N is determined by the first node from the first set of quantities of transmission times based on a first QoS requirement. It should be understood that the first set of quantities of transmission times may include one or more quantities of transmission times. In this way, the first node can determine N based on the QoS requirement of the first node.

For example, the first set of quantities of transmission times may be, for example, {2, 3}, and N may be, for example, 2 or 3.

In a possible implementation, the first set of quantities of transmission times may be indicated by the third node to the first node. It can be learned that, because the first set of quantities of transmission times is indicated by the third node to the first node, N determined by the first node based on the first set of quantities of transmission times can better satisfy the current QoS requirement of the first node for the service.

The third node indicates information about the first set of quantities of transmission times to the first node. Correspondingly, the first node receives the information that is about the first set of quantities of transmission times and that is indicated by the third node. The information about the first set of quantities of transmission times may be carried in, for example, MAC signaling or RRC signaling.

In a possible implementation, the first control information may include at least one of the following: path information, a quantity of transmission times of the first data corresponding to the first control information, or a first interval. The path information indicates a node through which the first node sends the first data to a destination node, and an interval between end time of transmission of the first group of data and start time of transmission of the second group of data is the first interval. It can be learned that, because the first control information includes the path information, in a multi-hop transmission scenario, the first node can learn of a next node of the first node, so that the first data can be forwarded to the next node. In addition, because the first control information may further include the quantity of transmission times of the first data corresponding to the first control information and/or the first interval, the second node may obtain the first data in the first group of data based on the quantity of transmission times of the first data corresponding to the first control information and/or the first interval. In addition, because the path information, the quantity of transmission times of the first data corresponding to the first control information, the first interval, and the like may be included in the first control information and sent to the second node, a plurality of signaling interactions are avoided, and transmission time is reduced.

In a possible implementation, the first control information may further include at least one of the following: a second interval, a modulation and coding scheme of the first data in the first group of data, or the like. The second interval is an interval between time domain positions of two adjacent pieces of first data in the first group of data. This indicates that the two adjacent pieces of first data in the first group of data are sent discontinuously. Even if the second node cannot receive a piece of first data in the first group of data when sending data at a first moment, because transmission of the first data included in the first group of data is discontinuous, the second node may still receive the other piece of first data in the first group of data at a second moment, so that the randomness of the half-duplex collision problem can be better handled. In this way, the requirement for high reliability is satisfied. In addition, the second node can learn of the modulation and coding scheme of the first data in the first group of data.

In a possible implementation, the second interval is indicated by the third node to the first node; or the second interval is determined by the first node based on a second interval set. This improves diversity of obtaining the second interval, so that the second interval determined by the first node based on the second interval set can better satisfy the current QOS requirement of the first node for the service.

The third node indicates information about the second interval to the first node. Correspondingly, the first node receives the information that is about the second interval and that is indicated by the third node. The information about the second interval may be carried in, for example, PHY layer signaling, MAC signaling, or RRC signaling. When the information about the second interval is carried in the PHY layer signaling, a dynamic adjustment indication is implemented based on a change of a channel status.

That the second interval is determined by the first node based on a second interval set includes: The second interval is determined by the first node from the second interval set based on the first QoS requirement. In this way, the first node can determine the second interval based on the QoS requirement of the first node.

In a possible implementation, the second interval set is indicated by the third node to the first node. It can be learned that, because the second interval set is indicated by the third node to the first node, the second interval determined by the first node based on the second interval set can better satisfy the current QoS requirement of the first node for the service.

The third node indicates information about the second interval set to the first node. Correspondingly, the first node receives the information that is about the second interval set and that is indicated by the third node. The information about the second interval set may be carried in, for example, RRC signaling or MAC signaling.

It should be understood that, in this application, for a manner of determining an interval between time domain positions of two adjacent pieces of first data included in a group of data other than the first group of data in the N groups of data, refer to a manner of determining the second interval. Details are not described herein again.

It should be noted that, when intervals between time domain positions of the every two adjacent pieces of first data in the first group of data are completely the same, it indicates that there is one interval that is between the time domain positions of the two adjacent pieces of first data and that needs to be carried in the first control information, so that overheads are reduced. In addition, it also indicates that the two adjacent pieces of first data in the first group of data are sent at equal intervals. When intervals between time domain positions of the every two adjacent pieces of first data in the first group of data are partially the same or completely different, it indicates that there are a plurality of intervals that are between the time domain positions of the two adjacent pieces of first data and that need to be carried in the first control information. The overheads, the self-decoding, and the problem that the receiving and the sending are not performed simultaneously due to the half-duplex can be better balanced, so that the better performance in terms of the reliability and the overheads is achieved. In addition, it also indicates that the two adjacent pieces of first data in the first group of data are sent at unequal intervals.

For example, the first group of data includes data 1, data 2, data 3, and data 4, where a time domain position of the data 1 is adjacent to a time domain position of the data 2, the time domain position of the data 2 is adjacent to a time domain position of the data 3, and the time domain position of the data 3 is adjacent to a time domain position of the data 4. For example, a length of an interval between the time domain positions of the data 1 and the data 2 is two subslots, a length of an interval between the time domain positions of the data 2 and the data 3 is two subslots, and a length of an interval between the time domain positions of the data 3 and the data 4 is two subslots. In other words, the intervals between the time domain positions of the every two adjacent pieces of first data in the first group of data are completely the same. For another example, a length of an interval between the time domain positions of the data 1 and the data 2 is two subslots, a length of an interval between the time domain positions of the data 2 and the data 3 is two subslots, and a length of an interval between the time domain positions of the data 3 and the data 4 is four subslots. In other words, the intervals between the time domain positions of the every two adjacent pieces of first data in the first group of data are partially the same. For another example, a length of an interval between the time domain positions of the data 1 and the data 2 is two subslots, a length of an interval between the time domain positions of the data 2 and the data 3 is four subslots, and a length of an interval between the time domain positions of the data 3 and the data 4 is six subslots. In other words, the intervals between the time domain positions of the every two adjacent pieces of first data in the first group of data are completely different.

In a possible implementation, in this application, intervals between time domain positions of two adjacent pieces of first data included in any one of the N groups of data may be completely the same, partially the same, or completely different. It should be understood that, when the intervals between the time domain positions of the every two adjacent pieces of first data included in the any one of the N groups of data are completely the same, there is no need to configure different intervals, and a configuration is simple, so that overheads can be reduced. When the intervals between the time domain positions of the every two adjacent pieces of first data included in the any one of the N groups of data are partially the same, configurations of different intervals can be reduced. When the intervals between the time domain positions of the every two adjacent pieces of first data included in the any one of the N groups of data are completely different, the randomness of the half-duplex collision problem can be better handled. In this way, the requirement for high reliability is satisfied.

In a possible implementation, intervals between time domain positions of two adjacent pieces of first data in different groups of the N groups of data may be completely the same, partially the same, or completely different. This is not limited herein. It should be understood that, when the intervals between the time domain positions of the every two adjacent pieces of first data in the different groups of the N groups of data are completely the same, there is no need to configure different intervals, and a configuration is simple, so that overheads can be reduced. When the intervals between the time domain positions of the every two adjacent pieces of first data in the different groups of the N groups of data are partially the same, configurations of different intervals can be reduced. When the intervals between the time domain positions of the every two adjacent pieces of first data in the different groups of the N groups of data are completely different, the randomness of the half-duplex collision problem can be better handled. In this way, the requirement for high reliability is satisfied.

For example, three groups of data are respectively a group 1, a group 2, and a group 3, and the group 1, the group 2, and the group 3 may each include two pieces of first data. For example, a length of an interval between time domain positions of the two pieces of first data in the group 1 is two subslots, a length of an interval between time domain positions of the two pieces of first data in the group 2 is two subslots, and a length of an interval between time domain positions of the two pieces of first data in the group 3 is two subslots. In other words, intervals between time domain positions of every two adjacent pieces of first data in different groups of the three groups of data are completely the same. For another example, a length of an interval between time domain positions of the two pieces of first data in the group 1 is two subslots, a length of an interval between time domain positions of the two pieces of first data in the group 2 is two subslots, and a length of an interval between time domain positions of the two pieces of first data in the group 3 is four subslots. In other words, intervals between time domain positions of every two adjacent pieces of first data in different groups of the three groups of data are partially the same. For another example, a length of an interval between time domain positions of the two pieces of first data in the group 1 is two subslots, a length of an interval between time domain positions of the two pieces of first data in the group 2 is four subslots, and a length of an interval between time domain positions of the two pieces of first data in the group 3 is six subslots. In other words, intervals between time domain positions of every two adjacent pieces of first data in different groups of the three groups of data are completely different.

It should be noted that, in this application, when the intervals between the time domain positions of the every two adjacent pieces of first data in the different groups of the N groups of data are completely the same, and the intervals between the time domain positions of the every two adjacent groups of data in the N groups of data are completely the same, it may be understood as that repetition is performed at equal intervals. When any one or more of the following cases are satisfied, it may be understood as that repetition is performed at unequal intervals.

Case 1: The intervals between the time domain positions of the every two adjacent pieces of first data included in the any one of the N groups of data are partially the same.

Case 2: The intervals between the time domain positions of the every two adjacent pieces of first data included in the any one of the N groups of data are completely different.

Case 3: The intervals between the time domain positions of the every two adjacent pieces of first data in the different groups of the N groups of data are partially the same.

Case 4: The intervals between the time domain positions of the every two adjacent pieces of first data in the different groups of the N groups of data are completely different.

Case 5: The intervals between the time domain positions of the every two adjacent groups of data in the N groups of data are partially the same.

Case 6: The intervals between the time domain positions of the every two adjacent groups of data in the N groups of data are completely different.

In a possible implementation, the first control information may further include a quantity of pieces of first data in the first group of data. In this way, the second node can learn of the quantity of pieces of first data in the first group of data.

In a possible implementation, the quantity of pieces of first data in the first group of data is indicated by the third node to the first node; or the quantity of pieces of first data in the first group of data is determined by the first node based on a second set of quantities of transmission times. This provides different manners to obtain the quantity of pieces of first data in the first group of data. In addition, the first node may determine the quantity of pieces of first data in the first group of data based on the second set of quantities of transmission times, so that the first node can determine the quantity of pieces of first data in the first group of data.

The third node indicates, to the first node, information about the quantity of pieces of first data in the first group of data. Correspondingly, the first node receives the information that is about the quantity of pieces of first data in the first group of data and that is indicated by the third node. The information about the quantity of pieces of first data in the first group of data may be carried in, for example, PHY layer signaling, MAC signaling, or RRC signaling. When the quantity of pieces of first data in the first group of data is carried in the PHY layer signaling, a dynamic adjustment indication is implemented based on a change of a channel status.

That the quantity of pieces of first data in the first group of data is determined by the first node based on a second set of quantities of transmission times includes: The quantity of pieces of first data in the first group of data is determined by the first node from the second set of quantities of transmission times based on the first QoS requirement. In this way, the first node can determine the quantity of pieces of first data in the first group of data based on the QOS requirement of the first node.

In a possible implementation, the second set of quantities of transmission times is indicated by the third node to the first node. It can be learned that, because the second set of quantities of transmission times is indicated by the third node to the first node, the quantity of pieces of first data in the first group of data that is determined by the first node based on the second set of quantities of transmission times can better satisfy the current QoS requirement of the first node for the service.

The third node indicates, to the first node, information about the second set of quantities of transmission times. Correspondingly, the first node receives the information that is about the second set of quantities of transmission times and that is indicated by the third node. The information about the second set of quantities of transmission times may be carried in RRC signaling or MAC signaling.

It should be noted that, in this application, the first interval set, the first set of quantities of transmission times, the second interval set, and the second set of quantities of transmission times may be carried in same signaling, or may be carried in different signaling. Similarly, the first interval, N, the second interval, and the quantity of pieces of first data in the first group of data may be carried in same signaling, or may be carried in different signaling.

In a possible implementation, the first control information is the same as the second control information. That the first control information is the same as the second control information may be understood as at least one of the following: A payload in the first control information is the same as a payload in the second control information, an indication field in the first control information is the same as an indication field in the second control information, or a quantity of indication bits included in the first control information is the same as a quantity of indication bits included in the second control information. In this way, same detection complexity is maintained, a same configuration is supported when channel conditions are the same or similar, and different meanings, for example, different modulation and coding schemes, are indicated based on channel changes.

It should be noted that, in this application, control information included in different groups of the N groups of data may be, for example, completely the same, partially the same, or completely different. This is not limited herein. It should be understood that, when the control information included in the different groups of the N groups of data is completely the same, there is no need to configure different control information, and a configuration is simple. When the control information included in the different groups of the N groups of data is partially the same, configurations of different control information can be reduced. When the control information included in the different groups of the N groups of data is completely different, the control information may indicate transmission of the first data. This indicates that the control information included in the different groups of the N groups of data has completely different indications for transmission of the first data, so that the randomness of the half-duplex collision problem can be better handled. In this way, the requirement for high reliability is satisfied.

It can be learned that, in the embodiment shown in FIG. 4, if a packet loss occurs in the first group of data, the second node may still obtain the P pieces of first data based on the second control information. This can improve data transmission reliability, and further satisfy the requirement for high reliability. Alternatively, if the second node does not obtain the first group of data due to the half-duplex problem, but the second node may further obtain a group of data other than the first group of data, the problem that the data cannot be simultaneously sent and received due to the half-duplex can be well resolved, so that the requirement for high reliability is satisfied.

In addition, one group of data includes one piece of control information and a plurality of pieces of first data, so that the piece of control information indicates transmission of the plurality of pieces of first data, and overheads are reduced.

In a possible implementation, the method may further include step 402.

402: The first node sends the N groups of data to the second node.

Correspondingly, the second node receives the N groups of data sent by the first node.

In a possible implementation, the method further includes: In response to a decoding error occurring after the first data in the N groups of data is received, and a cumulative quantity of transmission times of the first data in the first group to a N^{th} group not reaching a preset quantity of transmission times, the second node skips sending a NACK for the first data to the first node; or in response to a cumulative quantity of transmission times of the first data in the first group to a N^{th} group reaching a preset quantity of transmission times but a decoding error still occurring, the second node sends a NACK to the first node. It can be learned that, when the decoding error occurs after the first data in the N groups of data is received, and the cumulative quantity of transmission times of the first data in the first group to the N^{th} group does not reach the preset quantity of transmission times, the second node skips sending the NACK for the first data to the first node, so that the second node does not need to perform receive/transmit conversion, and time overheads caused by the receive/transmit conversion are reduced. When the cumulative quantity of transmission times of the first data in the first group to the N^{th} group reaches the preset quantity of transmission times but the decoding error still occurs, the second node sends the NACK to the first node, so that the first node can learn of a case in which the second node incorrectly decodes the first data.

“In response to a decoding error occurring after the first data in the N groups of data is received, and a cumulative quantity of transmission times of the first data in the first group to a N^{th} group not reaching a preset quantity of transmission times” may be understood as “when the decoding error occurs after the first data in the N groups of data is received, and the cumulative quantity of transmission times of the first data in the first group to the N^{th} group does not reach the preset quantity of transmission times”. Similarly, “in response to a cumulative quantity of transmission times of the first data in the first group to a N^{th} group reaching a preset quantity of transmission times but a decoding error still occurring” may be understood as “when the cumulative quantity of transmission times of the first data in the first group to the N^{th} group reaches the preset quantity of transmission times but the decoding error still occurs”.

In a possible implementation, a N^{th} piece of control information includes the cumulative quantity of transmission times of the first data in the first group to the N^{th} group. This indicates that the N^{th} piece of control information may include the cumulative quantity of transmission times of the first data in the first group to the N^{th} group, so that a problem that relay waiting time increases because the cumulative quantity of transmission times is separately sent can be resolved, and a forwarding delay can also be reduced. In a possible implementation, in this case, the preset quantity of transmission times may be, for example, a total quantity of all pieces of first data in the N groups of data.

In another possible implementation, the cumulative quantity of transmission times of the first data in the first group to the N^{th} group is determined based on a cumulative quantity of groups corresponding to the first data, and the cumulative quantity of groups corresponding to the first data is N. Because the cumulative quantity of groups corresponding to the first data indicates that a small quantity of bits is occupied, overheads can be reduced. In a possible implementation, in this case, the preset quantity of transmission times may be, for example, a quantity of data groups to which the first data belongs.

That the cumulative quantity of transmission times of the first data in the first group to the N^{th} group is determined based on a cumulative quantity of groups corresponding to the first data may be understood as that when quantities of pieces of first data included in different groups of the N groups of data are completely the same, the cumulative quantity of transmission times of the first data in the first group to the N^{th} group is determined based on the cumulative quantity of groups corresponding to the first data.

In a possible implementation, the cumulative quantity of groups corresponding to the first data may be carried in, for example, RRC signaling or MAC signaling.

It should be understood that, when the second node obtains a first resource used for sending feedback information, that the second node sends the NACK to the first node may be understood as that the second node sends the NACK to the first node on the first resource.

A manner in which the second node obtains the first resource may be, for example, any one of the following manners. It should be understood that a specific manner to be used to learn of the first resource may depend on an implementation of the second node, a pre-agreement, or a definition in a standard.

Manner 1.1: The first node receives first indication information sent by the third node, where the first indication information indicates the first resource used by the second node to send the feedback information, and the feedback information includes an ACK or the NACK for the first data; and the first node sends the first indication information to the second node, and correspondingly, the second node receives the first indication information sent by the first node. The first indication information may be carried in, for example, MAC signaling or RRC signaling. It can be learned that the first resource used by the second node to send the feedback information is indicated by the third node to the first node, and then is forwarded by the first node to the second node, so that a problem that a delay increases because the first node needs to configure a resource is avoided.

Manner 1.2: The first node allocates, to the second node, the first resource used for sending the feedback information, and sends the first resource to the second node, and correspondingly, the second node receives the first resource sent by the first node. In this way, the second node can learn of the first resource used for sending the feedback information.

In a possible implementation, the method further includes: In response to the first data in the N groups of data being correctly decoded after being received, the second node sends an ACK for the first data to the first node, and correspondingly, the first node receives the ACK sent by the second node. It should be understood that, when the first node obtains the ACK, and there is still first data to be sent to the second node in the N groups of data, the first node stops continuing sending the first data to the second node. It can be learned that when the first data in the N groups of data is correctly decoded after being received, the second node may send the ACK for the first data to the first node, so that the first node can stop, based on the ACK, continuing sending the first data to the second node, and overheads are reduced.

“In response to the first data in the N groups of data being correctly decoded after being received” may be understood as “when the first data in the N groups of data is correctly decoded after being received”.

It should be noted that, when the second node obtains the first resource used for sending the feedback information, that the second node sends the ACK for the first data to the first node may be understood as that the second node sends the ACK for the first data to the first node on the first resource.

To reduce a problem of interference between feeding back the ACK and forwarding the first data, any one of the following manners may be used. It should be understood that a specific manner to be used to learn of the first resource may depend on an implementation of the fourth node, a pre-agreement, or a definition in a standard.

Manner 2.1: In response to time in which the second node sends the ACK to the first node overlapping time in which the second node forwards the first data to the fourth node, the second node sends second indication information to the fourth node, and correspondingly, the fourth node receives the second indication information sent by the second node. The second indication information indicates a second resource used by the fourth node to forward the first data, the second resource does not include the first resource, and the first resource is used by the second node to send the ACK to the first node. “In response to time in which the second node sends the ACK to the first node overlapping time in which the second node forwards the first data to the fourth node” may be understood as “when the time in which the second node sends the ACK to the first node and the time in which the second node forwards the first data to the fourth node overlap”. The time in which the second node sends the ACK to the first node and the time in which the second node forwards the first data to the fourth node overlap, where the overlapping may be partial overlapping or complete overlapping. This is not limited herein. The second indication information may be carried in, for example, PHY layer signaling, MAC signaling, or RRC signaling. When the second indication information is carried in the PHY layer signaling, a dynamic adjustment indication is implemented based on a change of a channel status.

Manner 2.2: The fourth node receives third indication information sent by the third node, where the third indication information indicates a second resource used by the fourth node to forward the first data. The third indication information may be carried in, for example, MAC signaling or RRC signaling.

It should be noted that, in this application, time in which the second node forwards the first data to the fourth node may be preconfigured, or may be dynamically indicated. This is not limited herein.

In a possible implementation, the method may further include step 403.

403: The second node obtains the first data based on the N groups of data.

For example, the second node may obtain the K pieces of first data based on the first control information in the first group of data, and the second node may obtain the P pieces of first data based on the second control information in the second group of data. It should be understood that a manner of obtaining first data in a group other than the first group of data and the second group of data in the N groups of data is similar, and details are not described herein again.

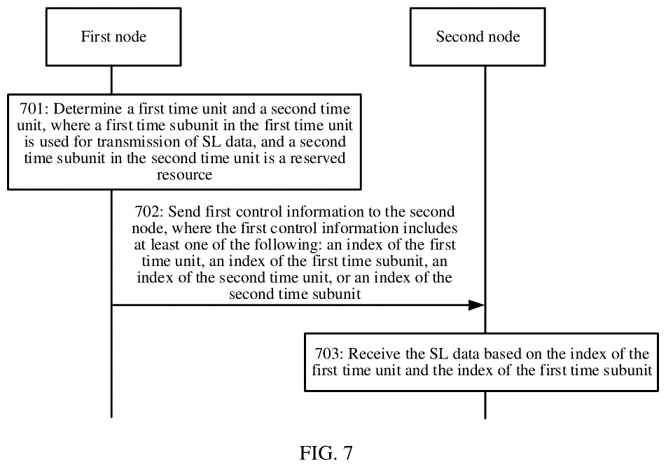

Currently, in an SL communication scenario, indexes of all slots (including 7 to 14 symbols) need to be indicated to another terminal device. This causes a high delay. To resolve this problem, refer to FIG. 7. FIG. 7 is a diagram of interaction of another communication method according to an embodiment of this application. A first node or a second node in the embodiment shown in FIG. 7 may be, for example, the terminal device in FIG. 1, and a third node in the embodiment shown in FIG. 7 may be, for example, the network device or the terminal device in FIG. 1. Alternatively, a first node or a second node in the embodiment shown in FIG. 7 may be, for example, the intermediate node in FIG. 2, and a third node in the embodiment shown in FIG. 7 may be, for example, the source node or the scheduling node in FIG. 2. The method includes but is not limited to the following steps.

701: The first node determines a first time unit and a second time unit, where a first time subunit in the first time unit is used for transmission of SL data, and a second time subunit in the second time unit is a reserved resource.

In the embodiment shown in FIG. 7, the time unit may be, for example, a slot, and the time subunit may be, for example, a subslot. Specifically, the first time unit may be, for example, a first slot, the first time subunit may be a first subslot, the second time unit may be, for example, a second slot, and the second time subunit may be a second subslot. The first time subunit is used for transmission of the SL data. In other words, the first subslot is used for transmission of the SL data. This indicates that this solution can support the subslot-based transmission, so that a requirement for a low delay can be satisfied.

In a possible implementation, the first time unit and the second time unit are included in second configuration information, and the second configuration information is indicated by the third node to the first node. The second configuration information may be carried in, for example, MAC signaling or RRC signaling. This indicates that the first time unit and the second time unit may be indicated by the third node to the first node, so that the first node does not need to determine the first time unit or the second time unit.

In a possible implementation, the first node is an intermediate node on a transmission path of the second configuration information, and the third node is a network device or a source node on the transmission path. This indicates that the second configuration information may be indicated, to the first node, by the network device or the source node on the transmission path, so that the first node does not need to determine the first time unit or the second time unit.

In a possible implementation, the second configuration information is transmitted hop by hop on the transmission path. In this way, any node on the transmission path of the second configuration information can obtain the second configuration information.

In another possible implementation, the first time unit and the second time unit are determined by the first node based on a QoS requirement of the first node for a service. This indicates that the first time unit and the second time unit are determined by the first node.

It should be noted that an index of a time subunit in the first time unit and an index of a time subunit in the second time unit may be implemented in any one of the following manners.

A specific manner to be used may depend on an implementation of the first node, a pre-agreement, or a definition in a standard.

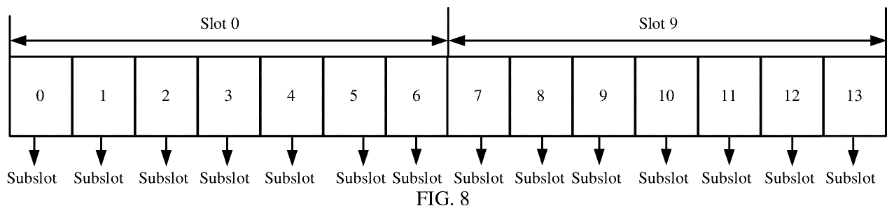

Manner 3.1: Time subunits in the first time unit and time subunits in the second time unit are jointly numbered. That time subunits in the first time unit and time subunits in the second time unit are jointly numbered may be understood as, for example, that the first node numbers the time subunits in the first time unit and the time subunits in the second time unit in a time sequence. For example, FIG. 8 is a diagram of joint numbering according to an embodiment of this application. As shown in FIG. 8, indexes of subslots in a slot 0 are respectively 0 to 6, and indexes of subslots in a slot 9 are respectively 7 to 13. The joint numbering helps reduce signaling indication overheads, and may further enable indexes of the time subunits in the first time unit and the second time unit to be different.

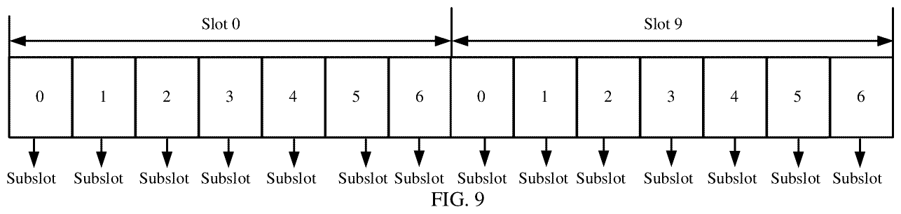

Manner 3.2: Time subunits in the first time unit and time subunits in the second time unit are independently numbered. That time subunits in the first time unit and time subunits in the second time unit are independently numbered may be understood as, for example, that the first node numbers the time subunits in the first time unit in a time sequence, and numbers the time subunits in the second time unit in the time sequence. For example, FIG. 9 is a diagram of independent numbering according to an embodiment of this application. As shown in FIG. 9, indexes of subslots in a slot 0 are respectively 0 to 6, and indexes of subslots in a slot 9 are respectively 0 to 6. In this way, the index of the time subunit in the first time unit and the index of the time subunit in the second time unit are not particularly large, and each quantity of bits that is separately indicated by the first node is fixed during indication, regardless of whether there is a configuration of another unit or a quantity of configurations of other units.

In a possible implementation, the method may further include: The first node receives first information sent by the third node, where the first information indicates one or more subslot length sets supported by the first node, and one subslot length set includes one or more subslot lengths; the first node determines a first subslot length based on the one or more subslot length sets; and the first node determines the time subunit in the first time unit and the time subunit in the second time unit based on the first subslot length. It can be learned that, because the first information indicates the one or more subslot length sets supported by the first node, and one subslot length set includes one or more subslot lengths, different subslot lengths are provided for the first node. In this way, the first node can select, with reference to QoS requirements of different services, an appropriate subslot length to determine the time subunit in the first time unit and the time subunit in the second time unit, to better satisfy requirements for a low delay and high reliability in the QoS requirements.

In a possible implementation, the subslot length may be understood as, for example, a quantity of symbols.

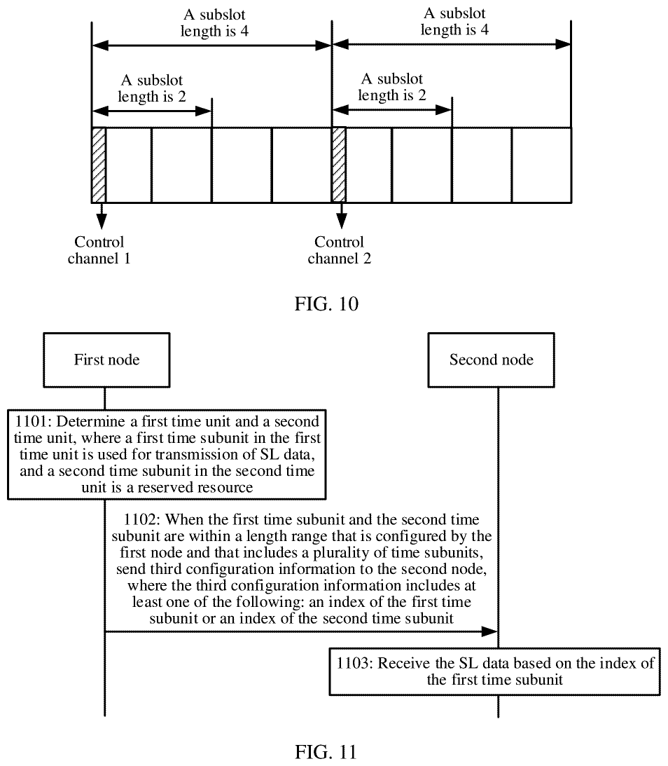

In a possible implementation, each subslot length in one subslot length set is in a multiple relationship with a minimum subslot length in the set. For example, one subslot length set may be, for example, {2, 4, 6, 8, 10, 12}, {4, 8, 12}, {3, 6, 9, 12}, or {6, 12}. It can be learned that in {2, 4, 6, 8, 10, 12}, a minimum subslot length is 2, where 4 is twice as much as 2, 6 is three times as much as 2, 8 is four times as much as 2, 10 is five times as much as 2, and 12 is six times as much as 2. In other words, 4, 6, 8, 10, and 12 are in the multiple relationship with the minimum subslot length. It can be learned that, because another subslot length in a plurality of subslot lengths is in the multiple relationship with the minimum subslot length, and a control channel is on the 1^{st} symbol of a subslot or a symbol before the subslot, a quantity of blind detection times can be reduced when blind detection is performed on control channels carried in the subslots in the multiple relationship. Specifically, FIG. 10 is a diagram of performing blind detection on a control channel according to an embodiment of this application. If blind detection is performed by using a subslot length 2, detection needs to be performed for four times. A control channel 1 is detected for the 1st time, and a control channel 2 is detected for the 3^{rd} time. If blind detection is performed by using a subslot length 4, detection needs to be performed twice. A control channel 1 is detected for the 1st time, and a control channel 2 is detected for the 2nd time. The subslot length 4 is twice as much as the subslot length 2, and a quantity of times of performing blind detection by using the subslot length 4 is less than a quantity of times of performing blind detection by using the subslot length 2.

That the first information indicates one or more subslot length sets supported by the first node may include, for example, that the first information indicates the one or more subslot length sets supported by a first group of nodes, and the first group of nodes includes the first node. It can be learned that the first information may indicate one or more subslot length sets supported by a group of nodes. This is equivalent to performing system-level or cell-level configuration, and a system transmission efficiency requirement is satisfied.

It should be noted that the first group of nodes may further include a node other than the first node.

In a possible implementation, the one or more subslot length sets supported by the first group of nodes may be determined by the third node based on a first QoS requirement of the first group of nodes, where the first QoS requirement is a QoS requirement of the one or more nodes in the first group of nodes for different services. For example, the first QoS requirement may be preconfigured in the third node, or may be received from the first group of nodes. For example, a minimum subslot length in one subslot length set is determined based on a highest delay requirement of the first group of nodes. For another example, a maximum subslot length in one subslot length set is determined based on a lowest delay requirement of the first group of nodes.

In a possible implementation, this solution may further include step 702.

702: The second node receives first control information sent by the first node, where the first configuration information includes at least one of the following: an index of the first time unit, an index of the first time subunit, an index of the second time unit, or an index of the second time subunit.

Correspondingly, the first node sends the first control information to the second node.

In a possible implementation, the first control information in FIG. 7 may further include content related to the first control information in FIG. 4. For details, refer to the first control information in FIG. 4. Details are not described herein again.

703: The second node receives the SL data based on the index of the first time unit and the index of the first time subunit.

It can be learned that this indicates that the first node indicates a resource to the second node in a level-based indication manner. To be specific, not only the index of the first time unit and the index of the second time unit are indicated, but also the index of the first time subunit in the first time unit and the index of the second time subunit in the second time unit are indicated. In this way, the second node can learn of a time subunit that is in a time unit and that is used for transmission of the SL data, and learn of a time subunit that is in a time unit and that is the reserved resource. In addition, a problem of excessively high overheads caused because indexes of time subunits in all time units need to be indicated to the second node without level-based indication can be avoided. In addition, the second node may receive the SL data based on the time subunit, the index of the first time unit, and the index of the first time subunit, so that a requirement for a low delay is satisfied.

Currently, in an SL communication scenario, indexes of all time units need to be indicated to another terminal device. This causes an excessively high delay. To resolve this problem, refer to FIG. 11. FIG. 11 is a diagram of interaction of another communication method according to an embodiment of this application. A first node or a second node in the embodiment shown in FIG. 11 may be, for example, the terminal device in FIG. 1, and a third node in the embodiment shown in FIG. 11 may be, for example, the network device or the terminal device in FIG. 1. Alternatively, a first node or a second node in the embodiment shown in FIG. 11 may be, for example, the intermediate node in FIG. 2, and a third node in the embodiment shown in FIG. 11 may be, for example, the source node or the scheduling node in FIG. 2. The method includes but is not limited to the following steps.

1101: The first node determines a first time unit and a second time unit, where a first time subunit in the first time unit is used for transmission of SL data, and a second time subunit in the second time unit is a reserved resource.

Step 1101 is similar to step 701 in FIG. 7, and details are not described herein again.

1102: The second node receives third configuration information sent by the first node, where the third configuration information includes at least one of the following: an index of the first time subunit or an index of the second time subunit.

Correspondingly, when the first time subunit and the second time subunit are within a length range that is configured by the first node and that includes a plurality of time subunits, the first node sends the third configuration information to the second node.

In a possible implementation, the third configuration information in FIG. 11 may further include content related to the first control information in FIG. 4. For details, refer to the first control information in FIG. 4. Details are not described herein again.

1103: The second node receives the SL data based on the index of the first time subunit.

It can be learned that this indicates that when the first time subunit and the second time subunit are within the length range that is configured by the first node and that includes the plurality of time subunits, the first node may directly indicate the index of the time subunit to the second node, so that overheads are reduced. In addition, the second node can learn of a time subunit that is used for transmission of the SL data, and learn of a time subunit that is the reserved resource.

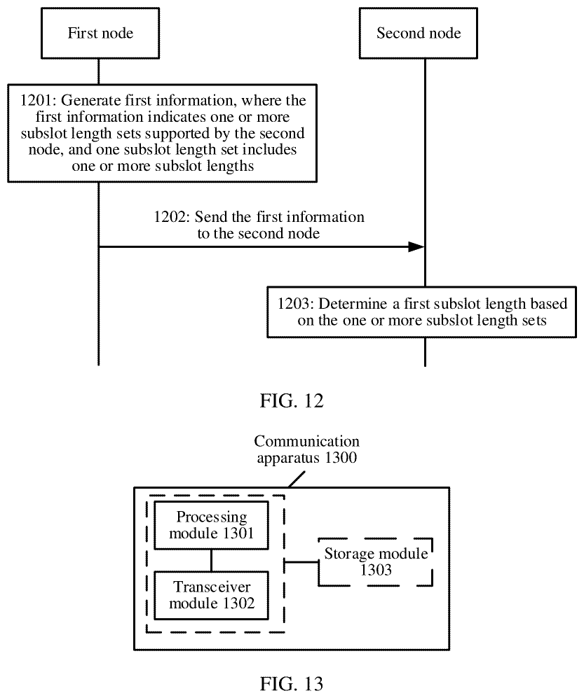

Currently, in each communication scenario, communication is usually performed based on a slot. This cannot satisfy requirements for a low delay and high reliability. To resolve this problem, refer to FIG. 12. FIG. 12 is a diagram of interaction of another communication method according to an embodiment of this application. A first node in the embodiment shown in FIG. 12 may be, for example, the network device or the terminal device in FIG. 1, and a second node in the embodiment shown in FIG. 12 may be, for example, the terminal device in FIG. 1. Alternatively, a first node in the embodiment shown in FIG. 12 may be, for example, the source node or the scheduling node in FIG. 2, and a second node in the embodiment shown in FIG. 12 may be, for example, the intermediate node in FIG. 2. The method includes but is not limited to the following steps.

1201: The first node generates first information, where the first information indicates one or more subslot length sets supported by the second node, and one subslot length set includes one or more subslot lengths.

In a possible implementation, the subslot length may be understood as, for example, a quantity of symbols. One subslot may be used for SL communication or Uu interface communication. This is not limited herein.

In a possible implementation, another subslot length in a plurality of subslot lengths in one subslot length set is in a multiple relationship with a minimum subslot length, and the another subslot length is a subslot length other than the minimum subslot length in the plurality of subslot lengths. For example, one subslot length set may be, for example, {2, 4, 6, 8, 10, 12}, {4, 8, 12}, {3, 6, 9, 12}, or {6, 12}. It can be learned that, because the another subslot length in the plurality of subslot lengths is in the multiple relationship with the minimum subslot length, and a control channel is on the 1st symbol of a subslot, a quantity of blind detection times can be reduced when blind detection is performed on control channels.

That the first information indicates one or more subslot length sets supported by the second node may include, for example, that the first information indicates the one or more subslot length sets supported by a first group of nodes, and the first group of nodes includes the second node. It can be learned that the first information may indicate one or more subslot length sets supported by a group of nodes. This is equivalent to performing system-level or cell-level configuration, and a system transmission efficiency requirement is satisfied.

It should be noted that the first group of nodes may further include a node other than the second node.

In a possible implementation, the one or more subslot length sets supported by the first group of nodes may be determined by the first node based on a first QoS requirement of the first group of nodes, where the first QoS requirement is a QoS requirement of one or more nodes in the first group of nodes for different services. For example, the first QoS requirement may be preconfigured in the first node, or may be received from the first group of nodes. For example, a minimum subslot length in one subslot length set is determined based on a highest delay requirement of the first group of nodes. For another example, a maximum subslot length in one subslot length set is determined based on a lowest delay requirement of the first group of nodes.

In a possible implementation, the first information may further indicate a configuration of a time unit supported by the second node, where the configuration of the time unit may include, for example, one or more of a number of the time unit, a quantity of symbols included in the time unit, and the like. In this way, the second node can learn of the configuration of the time unit.

In a possible implementation, the method further includes: The first node sends second information to the first group of nodes, where the second information indicates that a subslot length set available to the first group of nodes at a first moment is a first subslot length set and a subslot length set available to the first group of nodes at a second moment is a second subslot length set, the first subslot length set and the second subslot length set are subslot length sets supported by the first group of nodes, and the first subslot length set and the second subslot length set are different. This indicates that subslot length sets available to the first group of nodes at different moments are different, so that QoS requirements of the first group of nodes for different services at the different moments can be satisfied.

In a possible implementation, the method further includes: A third subslot length set and a fourth subslot length set are subslot length sets supported by the first group of nodes and a second group of nodes, the second group of nodes includes one or more nodes, and the method further includes: The first node sends third information to the first group of nodes, where the third information indicates that a subslot length set available to the first group of nodes is the third subslot length set; and the first node sends fourth information to the second group of nodes, where the fourth information indicates that a subslot length set available to the second group of nodes is the fourth subslot length set. The third subslot length set and the fourth subslot length set are different. This indicates that subslot length sets available to nodes in different groups are different, so that QoS requirements of the nodes in the different groups for different services can be satisfied.

In a possible implementation, an area in which the first group of nodes is located and an area in which the second group of nodes is located are different. For example, the area in which the first group of nodes is located and the area in which the second group of nodes is located may be preconfigured. This indicates that subslot length sets available to two groups of nodes in different areas are different, so that an interference problem can be avoided.

In a possible implementation, the method may further include: The first node receives a second QoS requirement sent by the first group of nodes, where the second QoS requirement is a QoS requirement updated by the one or more nodes in the first group of nodes; the first node updates, based on the second QoS requirement, the one or more subslot length sets supported by the first group of nodes; and the first node indicates one or more updated subslot length sets to the first group of nodes. This means that when the QoS requirement of the one or more nodes in the first group of nodes changes, the first node may also update, for the first group of nodes, the one or more subslot length sets supported by the first group of nodes.

In a possible implementation, the method may further include step 1202.

1202: The second node receives the first information sent by the first node.

Correspondingly, the first node sends the first information to the second node.

1203: The second node determines a first subslot length based on the one or more subslot length sets.

In a possible implementation, the first subslot length may be, for example, a subslot length determined by the second node from the one or more subslot length sets based on a QoS requirement of the second node for a service.

It can be learned that, because the first information indicates the one or more subslot length sets supported by the second node, one subslot length set includes one or more subslot lengths, and one subslot length is used for dividing a time unit into subslots, different subslot lengths are provided for the second node. In this way, the second node can select an appropriate subslot length with reference to QoS requirements of different services, to better satisfy requirements for a low delay and high reliability in the QoS requirements.

The foregoing mainly describes the solutions provided in this application from a perspective of interaction between devices. It may be understood that in the foregoing implementations, to implement the foregoing functions, each device includes a corresponding hardware structure and/or software module for performing each function. A person skilled in the art should easily be aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraint conditions of the technical solutions. A person skilled in the art may use different methods to implement the described functions for each particular application, but it should not be considered that the implementation goes beyond the scope of this application.

In embodiments of this application, the first node, the second node, or the like may be divided into functional modules based on the foregoing method examples. For example, each functional module may be obtained through division based on a corresponding function, or two or more functions may be integrated into one processing module. The integrated module may be implemented in a form of hardware, or may be implemented in a form of a software functional module. It should be noted that, in embodiments of this application, module division is an example, and is merely a logical function division. In actual implementation, another division manner may be used.

If the integrated module is used, refer to FIG. 13. FIG. 13 is a diagram of a structure of a communication apparatus according to an embodiment of this application. The communication apparatus 1300 may be applied to the method shown in the embodiment in FIG. 4, FIG. 7, FIG. 11, or FIG. 12. As shown in FIG. 13, the communication apparatus 1300 includes a processing module 1301 and a transceiver module 1302. The processing module 1301 may be one or more processors, and the transceiver module 1302 may be a transceiver or a communication interface. The communication apparatus may be configured to implement a function of the first node, the second node, or the like in any one of the foregoing method embodiments, or configured to implement a function of the network element in any one of the foregoing method embodiments.

The network element or network function may be a network element in a hardware device, a software function running on dedicated hardware, or a virtualization function instantiated on a platform (for example, a cloud platform). In a possible implementation, the communication apparatus 1300 may further include a storage module 1303, configured to store program code and data of the communication apparatus 1300.

In an example, when the communication apparatus is used as a first node or a chip used in the first node, the communication apparatus performs the steps performed by the first node in the foregoing method embodiments. The transceiver module 1302 is configured to support communication with a second node and the like. The transceiver module specifically performs a sending action and/or a receiving action performed by the first node in the embodiment in FIG. 4,

FIG. 7, FIG. 11, or FIG. 12, for example, supports the first node in performing step 401, and/or another process of the technology described in this specification. The processing module 1301 may be configured to support the communication apparatus 1300 in performing a processing action in the foregoing method embodiments, for example, support the first node in performing one or more steps in step 701, step 1101, and the like, and/or another process of the technology described in this specification.

In a possible implementation, the processing module 1301 is configured to generate N groups of data, where Nis an integer greater than 1; and the transceiver module 1302 is configured to send the N groups of data to the second node. A first group of data in the N groups of data includes first control information and K pieces of first data, the first control information indicates transmission of the K pieces of first data, and K is an integer greater than 1; and a second group of data in the N groups of data includes second control information and P pieces of first data, the second control information indicates transmission of the P pieces of first data, and P is an integer greater than or equal to 1.

In a possible implementation, an interval between end time of transmission of the first group of data and start time of transmission of the second group of data is a first interval.

In a possible implementation, the first interval is indicated by a third node to the first node; or the first interval is determined by the first node based on a first interval set.

In a possible implementation, the first interval set is indicated by the third node to the first node.

In a possible implementation, N is indicated by the third node to the first node; or Nis determined by the first node based on a first set of quantities of transmission times.

In a possible implementation, the first set of quantities of transmission times is indicated by the third node to the first node.

In a possible implementation, the first control information may include at least one of the following: path information, a quantity of transmission times of the first data corresponding to the first control information, or the first interval. The path information indicates a node through which the first node sends the first data to a destination node, and the interval between the end time of the transmission of the first group of data and the start time of the transmission of the second group of data is the first interval.

In a possible implementation, the first control information is the same as the second control information.

In a possible implementation, the transceiver module 1302 is further configured to: receive first indication information sent by the third node, where the first indication information indicates a first resource used by the second node to send feedback information, and the feedback information includes an ACK or a NACK for the first data; and send the first indication information to the second node.

In another possible implementation, the processing module 1301 is configured to determine a first time unit and a second time unit, where a first time subunit in the first time unit is used for transmission of SL data, and a second time subunit in the second time unit is a reserved resource. The transceiver module 1302 is configured to send first configuration information to the second node, where the first configuration information includes at least one of the following: an index of the first time unit, an index of the first time subunit, an index of the second time unit, or an index of the second time subunit.

In a possible implementation, the first time unit and the second time unit are included in second configuration information, and the second configuration information is indicated by the third node to the first node.

In a possible implementation, the first node is an intermediate node on a transmission path of the second configuration information, and the third node is a network device or a source node on the transmission path.

In a possible implementation, the second configuration information is transmitted hop by hop on the transmission path.

In a possible implementation, time subunits in the first time unit and time subunits in the second time unit are jointly numbered.

In a possible implementation, time subunits in the first time unit and time subunits in the second time unit are independently numbered.

In another possible implementation, the processing module 1301 is configured to generate first information, where the first information indicates one or more subslot length sets supported by the second node, and one subslot length set includes one or more subslot lengths. The transceiver module 1302 is configured to send the first information to the second node.

In a possible implementation, another subslot length in a plurality of subslot lengths is in a multiple relationship with a minimum subslot length, and the another subslot length is a subslot length other than the minimum subslot length in the plurality of subslot lengths.

In a possible implementation, that the first information indicates one or more subslot length sets supported by the second node includes: The first information indicates one or more subslot length sets supported by a first group of nodes, and the first group of nodes includes the second node.

In a possible implementation, the transceiver module 1302 is further configured to send second information to the first group of nodes, where the second information indicates that a subslot length set available to the first group of nodes at a first moment is a first subslot length set and a subslot length set available to the first group of nodes at a second moment is a second subslot length set, the first subslot length set and the second subslot length set are subslot length sets supported by the first group of nodes, and the first subslot length set and the second subslot length set are different.

In a possible implementation, a third subslot length set and a fourth subslot length set are subslot length sets supported by the first group of nodes and a second group of nodes, the second group of nodes includes one or more nodes, and the transceiver module 1302 is further configured to: send third information to the first group of nodes, where the third information indicates that a subslot length set available to the first group of nodes is the third subslot length set; and send fourth information to the second group of nodes, where the fourth information indicates that a subslot length set available to the second group of nodes is the fourth subslot length set. The third subslot length set and the fourth subslot length set are different.

In another possible implementation, the processing module 1301 is configured to determine the first time unit and the second time unit, where the first time subunit in the first time unit is used for transmission of the SL data, and the second time subunit in the second time unit is the reserved resource. The transceiver module 1302 is configured to: when the first time subunit and the second time subunit are within a length range that is configured by the first node and that includes a plurality of time subunits, send third configuration information to the second node, where the third configuration information includes at least one of the following: the index of the first time subunit or the index of the second time subunit.

In another example, when the communication apparatus is used as a second node or a chip used in the second node, the communication apparatus performs the steps performed by the second node in the foregoing method embodiments. The transceiver module 1302 is configured to support communication with a first node and the like. The transceiver module specifically performs a sending action and/or a receiving action performed by the second node in the embodiment in FIG. 4, FIG. 7, FIG. 11, or FIG. 12, for example, supports the second node in performing another process of the technology described in this specification. The processing module 1301 may be configured to support the communication apparatus 1300 in performing a processing action in the foregoing method embodiments, for example, support the second node in performing one or more steps in step 703, step 1103, and the like, and/or another process of the technology described in this specification.

In a possible implementation, the transceiver module 1302 is configured to receive N groups of data sent by the first node, where N is an integer greater than 1. The transceiver module 1302 is further configured to receive first data based on the N groups of data. A first group of data in the N groups of data includes first control information and K pieces of first data, the first control information indicates transmission of the K pieces of first data, and K is an integer greater than 1; and a second group of data in the N groups of data includes second control information and P pieces of first data, the second control information indicates transmission of the P pieces of first data, and P is an integer greater than or equal to 1.

In a possible implementation, an interval between end time of transmission of the first group of data and start time of transmission of the second group of data is a first interval.

In a possible implementation, the first interval is indicated by a third node to the first node; or the first interval is determined by the first node based on a first interval set.

In a possible implementation, the first interval set is indicated by the third node to the first node.

In a possible implementation, N is indicated by the third node to the first node; or Nis determined by the first node based on a first set of quantities of transmission times.

In a possible implementation, the first set of quantities of transmission times is indicated by the third node to the first node.

In a possible implementation, the first control information may include at least one of the following: path information, a quantity of transmission times of the first data corresponding to the first control information, or the first interval. The path information indicates a node through which the first node sends the first data to a destination node, and the interval between the end time of the transmission of the first group of data and the start time of the transmission of the second group of data is the first interval.

In a possible implementation, the first control information is the same as the second control information.

In a possible implementation, the transceiver module 1302 is further configured to: in response to a decoding error occurring after the first data in the N groups of data is received, and a cumulative quantity of transmission times of the first data in the first group to a N^{th} group not reaching a preset quantity of transmission times, skip sending a NACK for the first data to the first node, where a N^{th} piece of control information and Q pieces of first data are included in the N^{th} group of data, and Q is an integer greater than or equal to 1; or in response to a cumulative quantity of transmission times of the first data in the first group to a N^{th} group reaching a preset quantity of transmission times but a decoding error still occurring, send a NACK to the first node.

In a possible implementation, the N^{th} piece of control information includes the cumulative quantity of transmission times of the first data in the first group to the N^{th} group.

In a possible implementation, the cumulative quantity of transmission times of the first data in the first group to the N^{th} group is determined based on a cumulative quantity of groups corresponding to the first data, and the cumulative quantity of groups corresponding to the first data is N.

In a possible implementation, the transceiver module 1302 is further configured to: in response to time in which the second node sends an ACK to the first node overlapping time in which the second node forwards the first data to a fourth node, send second indication information to the fourth node, where the second indication information indicates a second resource used by the fourth node to forward the first data, the second resource does not include a first resource, and the first resource is used by the second node to send the ACK to the first node.

In another possible implementation, the transceiver module 1302 is configured to receive first configuration information sent by the first node, where the first configuration information includes at least one of the following: an index of a first time unit, an index of a first time subunit in the first time unit, an index of a second time unit or an index of a second time subunit in the second time unit, the first time subunit is used for transmission of SL data, and the second time subunit is a reserved resource. The processing module 1301 is configured to receive the SL data based on the index of the first time unit and the index of the first time subunit.

In a possible implementation, the first time unit and the second time unit are included in second configuration information, and the second configuration information is indicated by the third node to the first node.

In a possible implementation, the first node is an intermediate node on a transmission path of the second configuration information, and the third node is a network device or a source node on the transmission path.

In a possible implementation, the second configuration information is transmitted hop by hop on the transmission path.

In a possible implementation, time subunits in the first time unit and time subunits in the second time unit are jointly numbered.

In a possible implementation, time subunits in the first time unit and time subunits in the second time unit are independently numbered.

In another possible implementation, the transceiver module 1302 is configured to receive first information sent by the first node, where the first information indicates one or more subslot length sets supported by the second node, and one subslot length set includes one or more subslot lengths. The processing module 1301 is configured to determine a first subslot length based on the one or more subslot length sets.

In a possible implementation, another subslot length in a plurality of subslot lengths is in a multiple relationship with a minimum subslot length, and the another subslot length is a subslot length other than the minimum subslot length in the plurality of subslot lengths.

In a possible implementation, that the first information indicates one or more subslot length sets supported by the second node includes: The first information indicates one or more subslot length sets supported by a first group of nodes, and the first group of nodes includes the second node.

In still another possible implementation, the transceiver module 1302 is configured to receive third configuration information sent by the first node, where the third configuration information includes at least one of the following: the index of the first time subunit or the index of the second time subunit, the first time subunit is used for transmission of the SL data, and the second time subunit is the reserved resource. The processing module 1301 is configured to receive the SL data based on the index of the first time subunit.

In a possible implementation, when the terminal device or the network device is a chip, the transceiver module 1302 may be a communication interface, a pin, a circuit, or the like. The communication interface may be configured to input to-be-processed data into a processor, and may output a processing result of the processor to the outside. During specific implementation, the communication interface may be a general-purpose input/output (GPIO) interface, and may be connected to a plurality of peripheral devices (for example, a display (LCD), a camera (camera), a radio frequency (RF) module, and an antenna). The communication interface is connected to the processor through a bus.

The processing module 1301 may be a processor. The processor may execute computer-executable instructions stored in a storage module, so that the chip performs the method in any embodiment in FIG. 4, FIG. 7, FIG. 11, or FIG. 12.

Further, the processor may include a controller, an arithmetic unit, and a register. For example, the controller is mainly responsible for instruction decoding, and transmitting a control signal for an operation corresponding to the instructions. The arithmetic unit is mainly responsible for performing a fixed-point or floating-point arithmetic operation, a shift operation, a logic operation, and the like, and may also perform an address operation and address translation. The register is mainly responsible for saving a quantity of register operations, intermediate operation results, and the like that are temporarily stored during instruction execution. During specific implementation, a hardware architecture of the processor may be an ASIC architecture, a microprocessor without interlocked pipeline stages (MIPS) architecture, an advanced RISC machine (ARM) architecture, a network processor (NP) architecture, or the like. The processor may be a single-core or multi-core processor.

The storage module may be a storage module inside the chip, for example, a register or a cache. Alternatively, the storage module may be a storage module, for example, a ROM, another type of static storage device that can store static information and instructions, or a RAM, located outside the chip.

It should be noted that a function corresponding to each of the processor and the interface may be implemented by using a hardware design, may be implemented by using a software design, or may be implemented by a combination of software and hardware. This is not limited herein.

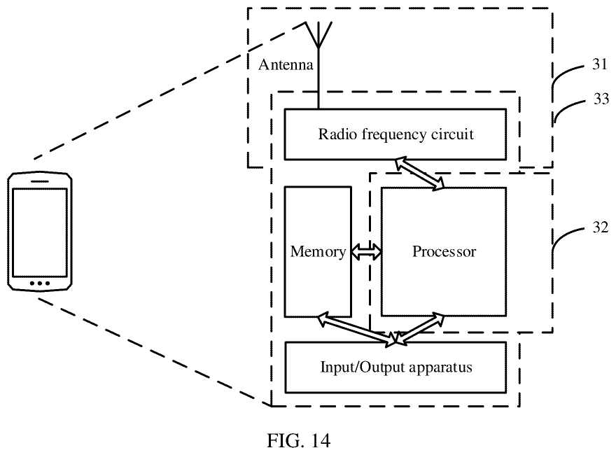

FIG. 14 is a diagram of a structure of a simplified terminal device according to an embodiment of this application. For ease of understanding and illustration, in FIG. 14, a mobile phone is used as an example of the terminal device. As shown in FIG. 14, the terminal device includes at least one processor, and may further include a radio frequency circuit, an antenna, and an input/output apparatus. The processor may be configured to process a communication protocol and communication data, and may be further configured to: control the terminal device, execute a software program, process data of the software program, and the like. The terminal device may further include a memory. The memory is mainly configured to store a software program and data. These related programs may be loaded into the memory when a communication apparatus is delivered from a factory, or may be loaded into the memory when needed later. The radio frequency circuit is mainly configured to: perform conversion between a baseband signal and a radio frequency signal, and process the radio frequency signal. The antenna is mainly configured to receive/send a radio frequency signal in an electromagnetic wave form, and the antenna is the antenna provided in embodiments of this application. The input/output apparatus, such as a touchscreen, a display, or a keyboard, is mainly configured to: receive data input by a user and output data to the user. It should be noted that some types of terminal devices may have no input/output apparatus.

When needing to send data, after performing baseband processing on the to-be-sent data, the processor outputs a baseband signal to the radio frequency circuit; and the radio frequency circuit performs radio frequency processing on the baseband signal and then sends a radio frequency signal to the outside in a form of an electromagnetic wave through the antenna. When data is sent to the terminal device, the radio frequency circuit receives the radio frequency signal through the antenna, converts the radio frequency signal into a baseband signal, and outputs the baseband signal to the processor. The processor converts the baseband signal into data, and processes the data. For ease of description, FIG. 14 shows only one memory and one processor. In an actual terminal device product, there may be one or more processors and one or more memories. The memory may also be referred to as a storage medium, a storage device, or the like. The memory may be disposed independent of the processor, or may be integrated with the processor. This is not limited in embodiments of this application.

In this embodiment of this application, an antenna having sending and receiving functions and the radio frequency circuit may be considered as a receiving unit and a sending unit (which may also be collectively referred to as a transceiver unit) of the terminal device, and a processor having a processing function may be considered as a processing unit of the terminal device. As shown in FIG. 14, the terminal device includes a receiving module 31, a processing module 32, and a sending module 33. The receiving module 31 may also be referred to as a receiver, a receiving machine, a receiver circuit, or the like. The sending module 33 may also be referred to as a sender, a transmitter, a transmitter machine, a transmitter circuit, or the like. The processing module 32 may also be referred to as a processor, a processing board, a processing apparatus, or the like.

For example, the processing module 32 is configured to perform a function of the terminal device in any embodiment shown in FIG. 4, FIG. 7, FIG. 11, or FIG. 12.

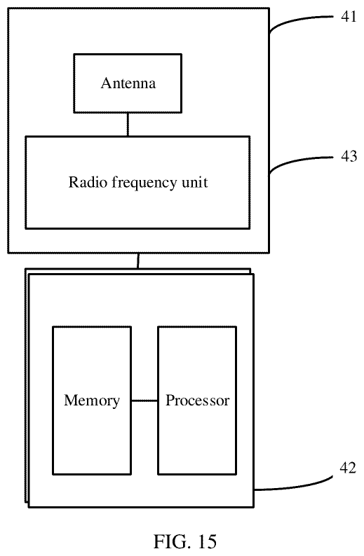

FIG. 15 is a diagram of a structure of a simplified network device according to an embodiment of this application. The network device includes a baseband part 42 and a part for radio frequency signal transmission/reception and conversion. The part for radio frequency signal transmission/reception and conversion further includes a receiving module 41 part and a sending module 43 part (which may also be collectively referred to as a transceiver module). The part for radio frequency signal transmission/reception and conversion is mainly configured to: send/receive a radio frequency signal and perform conversion between the radio frequency signal and a baseband signal. The baseband part 42 is mainly configured to: perform baseband processing, control the network device, and the like. The receiving module 41 may also be referred to as a receiver, a receiving machine, a receiver circuit, or the like. The sending module 43 may also be referred to as a sender, a transmitter, a transmitter machine, a transmitter circuit, or the like. The baseband part 42 is usually a control center of the network device, may also be referred to as a processing module, and is configured to perform steps performed by the network device in any embodiment shown in FIG. 4, FIG. 7, FIG. 11, or FIG. 12. For details, refer to the foregoing descriptions of the related parts.

The baseband part 42 may include one or more boards. Each board may include one or more processors and one or more memories. The processor is configured to read and execute a program in the memory, to implement a baseband processing function and control the network device. If there are a plurality of boards, the boards may be interconnected to improve a processing capability. In a possible implementation, the plurality of boards may share the one or more processors, the plurality of boards share the one or more memories, or the plurality of boards share the one or more processors at the same time.

For example, for a first network device, the sending module 43 is configured to perform a function of the network device in any embodiment shown in FIG. 4, FIG. 7, FIG. 11, or FIG. 12.

An embodiment of this application provides a communication apparatus, including a processor coupled to a memory. The processor is configured to execute a computer program or instructions stored in the memory, to implement the method according to any one of embodiments shown in FIG. 4, FIG. 7, FIG. 11, or FIG. 12.

In a possible implementation, the communication apparatus further includes the memory, and the memory and the processor are coupled to each other. In a possible implementation, the memory and the processor are integrated together.

In a possible implementation, the communication apparatus further includes a transceiver, and the transceiver is configured to receive and send data and/or signaling.

An embodiment of this application provides a communication apparatus, including a processor and an interface circuit. The interface circuit is configured to: receive a signal from a communication apparatus other than the communication apparatus and transmit the signal to the processor, or send a signal from the processor to a communication apparatus other than the communication apparatus, and the processor is configured to implement, by using a logic circuit or executing instructions, the method according to any one of embodiments shown in FIG. 4, FIG. 7, FIG. 11, or FIG. 12.

An embodiment of this application provides a computer-readable storage medium. The storage medium stores a computer program or instructions. When the computer program or the instructions are executed by a communication apparatus, the method according to any one of embodiments shown in FIG. 4, FIG. 7, FIG. 11, or FIG. 12 is performed.

An embodiment of this application provides a computer program product including instructions. When the computer program product runs on a computer, the method according to any one of embodiments shown in FIG. 4, FIG. 7, FIG. 11, or FIG. 12 is performed.

When the computer instructions are loaded and executed on the computer, all or some of the procedures or functions according to embodiments of this application can be implemented. The computer may be a general-purpose computer, a dedicated computer, a computer network, or another programmable apparatus. The computer instructions may be stored in a computer-readable storage medium, or may be transmitted by using a computer-readable storage medium. The computer-readable storage medium may be any usable medium accessible by a computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

Sequence adjustment, combination, or deletion may be performed on the steps in the method embodiments of this application based on an actual requirement.

Modules in the apparatus embodiments of this application may be combined, divided, or deleted based on an actual requirement.

1. A communication method, comprising:
generating, by a first node, N groups of data, wherein N is an integer greater than 1; and
sending, by the first node, the N groups of data to a second node, wherein
a first group of data in the N groups of data comprises first control information and K pieces of first data, the first control information indicates transmission of the K pieces of first data, and K is an integer greater than 1; and
a second group of data in the N groups of data comprises second control information and P pieces of first data, the second control information indicates transmission of the P pieces of first data, and P is an integer greater than or equal to 1.

2. The method according to claim 1, wherein the method further comprises:
receiving, by the first node, first indication information sent by a third node, wherein the first indication information indicates a first resource used by the second node to send feedback information, and the feedback information comprises an acknowledgement or a non-acknowledgement for the first data; and
sending, by the first node, the first indication information to the second node.

3. The method according to claim 1, wherein an interval between end time of transmission of the first group of data and start time of transmission of the second group of data is a first interval.

4. The method according to claim 3, wherein
the first interval is indicated by the third node to the first node; or
the first interval is determined by the first node based on a first interval set.

5. The method according to claim 4, wherein the first interval set is indicated by the third node to the first node.

6. The method according to claim 1, wherein
N is indicated by the third node to the first node; or
N is determined by the first node based on a first set of quantities of transmission times.

7. The method according to claim 6, wherein the first set of quantities of transmission times is indicated by the third node to the first node.

8. The method according to claim 1, wherein the first control information comprises at least one of the following: path information, a quantity of transmission times of the first data corresponding to the first control information, or the first interval; and
the path information indicates a node through which the first node sends the first data to a destination node, and the interval between the end time of the transmission of the first group of data and the start time of the transmission of the second group of data is the first interval.

9. The method according to claim 1, wherein the first control information is the same as the second control information.

10. A communication method, comprising:
receiving, by a second node, N groups of data sent by a first node, wherein N is an integer greater than 1;
a first group of data in the N groups of data comprises first control information and K pieces of first data, the first control information indicates transmission of the K pieces of first data, and K is an integer greater than 1; and
a second group of data in the N groups of data comprises second control information and P pieces of first data, the second control information indicates transmission of the P pieces of first data, and P is an integer greater than or equal to 1; and
obtaining, by the second node, the first data based on the N groups of data.

11. The method according to claim 10, wherein the method further comprises:
in response to a decoding error occurring after the first data in the N groups of data is received, and a cumulative quantity of transmission times of the first data in the first group to a N^{th} group not reaching a preset quantity of transmission times, skipping, by the second node, sending a non-acknowledgement for the first data to the first node; or
in response to a cumulative quantity of transmission times of the first data in the first group to a N^{th} group reaching a preset quantity of transmission times but a decoding error still occurring, sending, by the second node, a non-acknowledgement to the first node.

12. The method according to claim 11, wherein a control information corresponding to the N^{th} group comprises the cumulative quantity of transmission times of the first data in the first group to the N^{th} group; or
the cumulative quantity of transmission times of the first data in the first group to the N^{th} group is determined based on a cumulative quantity of groups corresponding to the first data, and the cumulative quantity of groups corresponding to the first data is N.

13. The method according to claim 10, wherein the method further comprises:
in response to time in which the second node sends an acknowledgement to the first node overlapping time in which the second node forwards the first data to a fourth node, sending, by the second node, second indication information to the fourth node, wherein the second indication information indicates a second resource used by the fourth node to forward the first data, the second resource does not comprise a first resource, and the first resource is used by the second node to send the acknowledgement to the first node.

14. The method according to claim 10, wherein an interval between end time of transmission of the first group of data and start time of transmission of the second group of data is a first interval.

15. The method according to claim 14, wherein
the first interval is indicated by the third node to the first node; or
the first interval is determined by the first node based on a first interval set.

16. The method according to claim 15, wherein the first interval set is indicated by the third node to the first node.

17. The method according to claim 10, wherein
N is indicated by the third node to the first node; or
N is determined by the first node based on a first set of quantities of transmission times.

18. The method according to claim 10, wherein the first control information comprises at least one of the following: path information, a quantity of transmission times of the first data corresponding to the first control information, or the first interval; and
the path information indicates a node through which the first node sends the first data to a destination node, and the interval between the end time of the transmission of the first group of data and the start time of the transmission of the second group of data is the first interval.

19. A signal transmission apparatus, comprising at least one processor, and one or more memories coupled to the at least one processor and storing programming instructions for execution by the at least one processor to perform operations comprising:
generating, by a first node, N groups of data, wherein N is an integer greater than 1; and
sending, by the first node, the N groups of data to a second node, wherein
a first group of data in the N groups of data comprises first control information and K pieces of first data, the first control information indicates transmission of the K pieces of first data, and K is an integer greater than 1; and
a second group of data in the N groups of data comprises second control information and P pieces of first data, the second control information indicates transmission of the P pieces of first data, and P is an integer greater than or equal to 1.

20. The apparatus according to claim 19, wherein the operations comprise:
receiving, by the first node, first indication information sent by a third node, wherein the first indication information indicates a first resource used by the second node to send feedback information, and the feedback information comprises an acknowledgement or a non-acknowledgement for the first data; and
sending, by the first node, the first indication information to the second node.
